(19) United States
(12) Patent Application Publication
(10) Pub. No.: US 2005/0265183 A1
(43) Pub. Date: Dec. 1, 2005

(54) Optical information recording apparatus

(76) Inventors: Hiroya Kakimoto, Gunma (JP); Mitsuo Sekiguchi, Gunma (JP); Isao Matsuda, Gunma (JP); Yoshikazu Sato, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/123,649

(22) Filed: May 5, 2005

(30) Foreign Application Priority Data
May 7, 2004 (JP) 2004-138776

(51) Int. Cl. G11B 5/09

(52) U.S. Cl. 369/47.53; 369/47.5; 369/53.1; 369/59.1

(57) ABSTRACT

There is provided an effective inspection technique of recording quality decided by a combination of a drive and a media. A standard media as a quality standard for various media is recorded and reproduced for each drive, thresholds obtained by multiplying a characteristic value obtained as a result of the record reproduction by a preset factor are stored in a storage area within each drive. When a record of information in a record object media is performed, the record object media is recorded and reproduced using a plurality of recording conditions accompanied with change of a power or a pulse width, an approximation curve is obtained from a plurality of characteristic values obtained as a result of the record reproduction, and the recording quality inspection of the media is performed based on the amount of margin obtained according to a positional relationship between the approximation curve and the threshold.

### BACKGROUND OF THE INVENTION

1. Field of the Invention

The present invention relates to optical information recording apparatuses such as optical disk recording apparatuses, and more particularly, to an optical information recording apparatus equipped with an effective inspection means for a recording quality.

2. Description of the Related Art

For recording of an optical information recording media (hereinafter, referred to as media) represented by CD-R or DVD-R, compatibility between the media for record and a recording apparatus for record (hereinafter, referred to as a drive) depends on a combination thereof. Factors for this may include a media factor that the optimum recording condition is varied depending on a material of the media and un-uniformity of film formation upon manufacturing of the media and a drive factor that the optimum condition is varied depending on pickups or semiconductor lasers, which constitute the drive, or un-uniformity of assembly in manufacture of the drive. Actually, in consideration of a mixture of these factors, recording conditions adaptable to each combination of the media and the drive exist.

Accordingly, there has been conventionally used a method where ID information by which the kind of a corresponding media is distinguishable by the drive is stored in the media, recording conditions preset for each kind of the media are stored in the drive, and, when an actual record is conducted, the ID information of the media is read from the media loaded in the drive and a recording condition associated with the ID information is used.

However, with such conventional methods, although proper recording conditions may be chosen for existing verified media to some degree, thorough measures to unknown unverified media may not be made under prepared recording conditions. In addition, even for the known media, measures may not be made due to variation of record environments, for example, a record speed, a disturbance, or a change with the lapse of time, under the prepared recording conditions.

A method disclosed in Patent Document 1 has been known as one example of measures against such a difficulty of record as mentioned above (JP-A-2003-331427, where a technique in which a record under a condition that data cannot be read may be avoided by using an error rate or a jitter value as an inspection index of a recording quality is disclosed.

Specifically, the patent document 1 discloses that “There is the optimum recording power or the optimum amount of strategy adjustment for the best quality of a data signal since it depends on the recording power or the amount of strategy adjustment”, as described in paragraph 0068 in the above patent document, and discloses that “A record by an excessive recording power to make data unreadable can be prevented by checking the quality of the data signal for each strategy adjustment value”, as described in paragraph 0069 in the above patent document.

In addition, for an example where the error rate is used as the inspection index of a recording quality, it is disclosed that “The optimum power record is obtained for each of a plurality of amounts of strategy adjustment, a fixed interval to a plurality of addresses is recorded with the optimum recording power, and the error rate of the data signal in the fixed interval is evaluated. In addition, if the error rate is bad, by preventing the record from being performed in a setting of a combination of the strategy adjustment amount and the optimum power, the data can be prevented from being unreadable”, as described in paragraph 0070 in the above patent document.

In addition, for an example where the jitter is used as the inspection index of a recording quality, it is disclosed that “The optimum power record is obtained for each of the plurality of amounts of strategy adjustment, a fixed interval is recorded with the optimum recording power, and the jitter value of a reproduction signal in the fixed interval is measured. If the jitter value of the reproduction signal is larger than a specific value, by preventing the record from being performed in a setting of a combination of the amount of strategy adjustment and the optimum power, the address information can be prevented from being unreadable due to the record”, as described in paragraph 0071 in the above patent document.

For the reason of using the error rate or the jitter as the inspection index of a recording quality, it is disclosed that “Generally, although the optimum recording power is determined using β in the CD-R and a modulation level m in the CD-RW, the best record is not always achieved in this method”, as described in paragraph 0069 in the above patent document.

By the technique disclosed in Patent Document 1 with the above-mentioned characteristics, since the record in such a condition that the data cannot be read can be prevented, an effect of saving a PCA area may be achieved, as described in the above document.

However, in the technique of the above Patent Document 1, the precision for the inspection index of a recording quality is insufficient and the error rate and the jitter value are insufficient as an index to evaluate the compatibility between the drive and the media, which have more severe record environment. Although this technique apparently discloses that the error rate and the jitter value are more appropriate as the inspection index of a recording quality than the β value and the modulation level, and also, discloses a means for determining whether data is readable or unreadable and for statistically evaluating a plurality of addresses for the error rate, it fails to draw more limitative compatibility between the drive and the media.

### SUMMARY OF THE INVENTION

It is therefore an object of the present invention to provide an effective inspection technique of a recording quality decided by a combination of a drive and a media.

In order to achieve the above-mentioned object, a first aspect of the present invention provides an optical information recording apparatus for recording information on an optical recording media by pulse irradiation of laser light, including a means for obtaining a recording margin by comparing a reproduction characteristic with a preset standard value, the reproduction characteristic being obtained by record reproduction of the optical recording media, and inspecting a recording quality based on a size of the recording margin.

Here, the recording margin means a range of a recording condition satisfying a preset reproduction standard. For example, if a jitter value is taken as an index of the reproduction standard and the recording condition is defined by a power and a pulse width of the laser light, a range of power having a jitter value below a preset threshold, i.e., a power margin, and a range of pulse width having the jitter value below the preset threshold, i.e., a pulse margin correspond to the recording margin. As the index of the reproduction standard, an error rate in addition to the jitter may be used, and in addition, a characteristic index such as a β value or a modulation level may be used although it may give poor precision.

Thus, the technique for inspecting the recording quality based on the recording margin allows more precise evaluation than the technique for inspecting the recording quality based on a determination whether or not a standard value is simply satisfied.

Preferably, the record reproduction is accompanied with change of a power condition of the laser light and/or a pulse condition of the pulse irradiation. In this way, by performing the record reproduction with the plurality of conditions, it is possible to provide more accurate quality evaluation.

Preferably, the recording margin is determined according to the amount of difference between power values of two large and small points satisfying the standard value, the power values being derived from an approximation of a recording characteristic of the optical recording media using a plurality of reproduction values obtained by the record reproduction, or the recording margin is determined according to a relationship between the standard value and an approximation of a recording characteristic of the optical recording media using a plurality of reproduction values obtained by the record reproduction, or the recording margin is determined according to the amount of difference between power values of two large and small points selected from a plurality of reproduction values obtained by the record reproduction, the two points being closest to the standard value, or the recording margin is determined according to the amount of difference between the standard value and two points selected from a plurality of reproduction values obtained by the record reproduction, the two points being closest to the standard value, or the recording margin is determined in consideration of a power upper bound value of the laser light.

A second aspect of the present invention provides an optical information recording apparatus for recording information on an optical recording media by pulse irradiation of laser light, including a means for obtaining a recording margin by comparing a reproduction characteristic with a preset standard, the reproduction characteristic being obtained by performing a test recording on the optical recording media before the information is recorded and by reproducing a result of the test recording, inspecting a recording quality based on a size of the recording margin, and informing a result of the inspection of the recording quality before the information is recorded.

Here, informing of the result of the inspection of the recording quality may include a warning to a user, notification of the recording condition or quality, notification of record compatibility, notification of recommendation of media exchange, request for measures or decision to the user, notification of cause of obtainment of the quality, stop of record operation, etc.

More specifically, techniques for informing to a user may employ change of disk rotational speed, mechanical operation of the drive, methods of informing the user using auditory techniques such as a buzzer, melody, or voice, opening/closing, blinking, and lighting on of a disk tray, display change of an access lamp such as change of an LED, methods of informing the user using visual techniques such as display on a display device installed in the drive.

In addition, various informing techniques, such as methods of informing a computer to which the drive is connected, display on an external display device, record of specific information into the media, voice output from an external speaker, through an output of electric signals, such as output of error signals according to a command issue timing of the drive, may be applied.

In this way, since a recordable amount of margin of the media can be told by informing the user of the result of the recording quality inspection, a record under a more stable condition is possible. In addition, since the user can know a media having good compatibility with the drive, it is possible to avoid a record under a difficult condition by selecting a media suitable to his own drive.

A third aspect of the present invention provides an optical information recording apparatus for recording information on an optical recording media by pulse irradiation of laser light, wherein a recording margin is obtained by comparing a reproduction characteristic with a preset standard, the reproduction characteristic being obtained by performing a test recording on the optical recording media before the information is recorded and by reproducing a result of the test recording, a recording quality is inspected based on a size of the recording margin, and a recording condition when the information is recorded is determined based on a result of the inspection of the recording quality.

With this configuration, by determining the optimum recording condition according to the result of highly precise quality inspection obtained using the recording margin, it is possible to cope with a more severe record environment.

A fourth aspect of the present invention provides an optical information recording apparatus for recording information on an optical recording media by pulse irradiation of laser light, wherein a recording margin is obtained by comparing a reproduction characteristic with a preset standard, the reproduction characteristic being obtained by performing a test recording on the optical recording media before the information is recorded and by reproducing a result of the test recording, a recording quality is inspected based on a size of the recording margin, a recording condition of the information record is determined based on a condition of the performed test recording if it is determined as a result of the inspection of a recording quality that it is appropriate to perform the record on the media, and, if it is determined that it is not appropriate to perform the record on the media, the inappropriateness is informed.

For example, if a β value is −10% or lower, a jitter is 13% or more for a clock cycle, a phase shift of front end/rear end of the record pulse is not less than regulated amount, a land 3 T jitter is higher than a regulated value, a pit 3 T jitter is higher than a regulated value, and an error rate is higher than a regulated value, it is determined that it is inappropriate to perform a record on the media, and thus, the record under an inappropriate condition can be avoided by performing the above-described informing operation.

A fifth aspect of the present invention provides an optical information recording apparatus for recording information on an optical recording media by pulse irradiation of laser light wherein a recording margin is obtained by comparing a reproduction characteristic with a preset standard, the reproduction characteristic being obtained by performing a test recording on the optical recording media before the information is recorded and by reproducing a result of the test recording, a recording quality based on a size of the recording margin is inspected, a recording condition of the information record is determined based on a condition of the test recording if it is determined as a result of the inspection of a recording quality that it is appropriate to perform the record on the media, and, if it is determined that it is not appropriate to perform the record on the media, specific measures are taken.

Preferably, the measures include changing a recording power condition and/or a pulse width condition when the information is recorded, or the measures include recording the information based on the recording condition obtained by repeating the test recording until a desired recording quality is obtained, or the measures include lowering a record speed when the information is recorded. Or, based on a margin result for the threshold, although the user is informed of record difficulty, the optimum recording condition may be obtained by changing the threshold to a level according to a characteristic of the media for which the test recording is performed, according to the user's intention.

In this way, by taking the measures against an inappropriate record environment, a record miss or data loss can be prevented so that a more stable record environment can be provided.

A sixth aspect of the present invention provides an optical information recording apparatus for recording information on an optical recording media by pulse irradiation of laser light, including a means for obtaining a recording margin by comparing a reproduction characteristic with a preset standard value, the reproduction characteristic being obtained by record reproduction of the optical recording media, inspecting a recording quality based on a size of the recording margin, and learning a result of the inspection of recording quality.

Preferably, the learning includes storing the recording quality and a recording condition from which the recording quality is obtained, with the recording quality and the recording condition associated to each other, or the learning includes storing unique information of the media obtained from the inspected recording quality, or the learning includes storing unique information of the device for the media obtained from the inspected recording quality.

By performing such learning, when a record under the same condition is assumed, an inspection process can be omitted, and therefore, the test recording area of the media can be effectively used. Accordingly, preferably, the recording quality inspection is performed based on a result of previous learning before the record reproduction is performed for the optical recording media.

As described above, according to the present invention, since the compatibility between the drive and the media can be evaluated with high precision, the record under an inappropriate environment can be avoided and it is possible to cope with a combination of the drive and the media, in which information could not be recorded by the conventional techniques. In addition, the recording condition that cannot be optimized by the conventional technique can be optimized by the technique according to the invention.

### BRIEF DESCRIPTION OF THE DRAWINGS

FIG. 1 is a block diagram illustrating the entire configuration of an optical information record medium and an optical information recording apparatus according to the present invention;

FIG. 2 is a flow chart illustrating a series of sequences performed by a drive according to the present invention;

FIG. 3 is a flow chart illustrating the detail of a decision step of a standard threshold shown in FIG. 2;

FIG. 4 is a conceptual diagram illustrating one embodiment of the flow shown in FIG. 3;

FIG. 5 is a conceptual diagram illustrating one embodiment of the flow shown in FIG. 3;

FIG. 6 is a conceptual diagram illustrating an example of a method of obtaining a threshold for each drive;

FIG. 7 is a conceptual diagram illustrating an example of a method of setting an average of thresholds obtained in a plurality of drives as a threshold of a different drive;

FIG. 8A and FIG. 8B are conceptual diagrams illustrating examples of a valley type pattern obtained as a result of recording characteristic inspection performed in Step S20 of FIG. 2;

FIG. 9A and FIG. 9B are conceptual diagrams illustrating examples of a right-descending pattern obtained as a result of recording characteristic inspection performed in Step S20 of FIG. 2;

FIG. 10A and FIG. 10B are conceptual diagrams illustrating examples of a right-ascending pattern obtained as a result of recording characteristic inspection performed in Step S20 of FIG. 2;

FIG. 11 is a conceptual diagram illustrating an example of test area decision performed in Step S22 of FIG. 2 when the valley type pattern is obtained in Step S20 of FIG. 2;

FIG. 12 is a conceptual diagram illustrating an example of test area decision performed in Step S22 of FIG. 2 when the right-descending pattern is obtained in Step S20 of FIG. 2;

FIG. 13 is a conceptual diagram illustrating an example of test area decision performed in Step S22 of FIG. 2 when the right-ascending pattern is obtained in Step S20 of FIG. 2;

FIG. 14 is a diagram illustrating an example in which Step S20 of FIG. 2 is performed using 8 patterns;

FIG. 15 is a conceptual diagram illustrating one example of a method of obtaining a range of power used in Step S22 of FIG. 2 based on a curve approximation;

FIG. 16 is a conceptual diagram illustrating another example of a method of obtaining a range of power used in Step S22 of FIG. 2 based on a curve approximation;

FIG. 17 is a conceptual diagram illustrating an example of a method of obtaining a range of power used in Step S22 of FIG. 2 based on a sampling;

FIG. 18A and FIG. 18B are conceptual diagrams illustrating examples of a pulse pattern used for a test recording of Step S24 of FIG. 2;

FIG. 19A and FIG. 19B are conceptual diagrams illustrating examples of another adjustment factor decided in Step S26 of FIG. 2;

FIG. 20A and FIG. 20B are conceptual diagrams illustrating another example of another adjustment factor decided in Step S26 of FIG. 2;

FIG. 21 is a conceptual diagram illustrating an example in which a test area reaches a position exceeding a threshold;

FIG. 22 is a conceptual diagram illustrating an example in which a test area reaches a position at which a pole of a range of power is obtained in addition to the process of FIG. 21;

FIG. 23 is a conceptual diagram illustrating an example in which a range between two points in the neighborhood of a threshold is taken as a range of power;

FIG. 24 is a conceptual diagram illustrating an example in which a range of power is divided into fine steps;

FIG. 25 is a conceptual diagram illustrating an example in which a test area reaches a position at which a pole of a range of power is obtained in addition to the process of FIG. 24;

FIG. 26 is a conceptual diagram illustrating an example in which a range of modification of a pulse width modified to a position exceeding a threshold is taken as a test area;

FIG. 27 is a conceptual diagram illustrating an example in which a test area reaches a position at which a pole of a range of pulse is obtained in addition to the process of FIG. 26;

FIG. 28 is a conceptual diagram illustrating an example in which a range of pulse is changed into fine steps;

FIG. 29 is a conceptual diagram illustrating an example in which a test area reaches a position at which a pole of the minimum jitter is obtained in addition to the process of FIG. 21;

FIG. 30 is a conceptual diagram illustrating an example in which a test area reaches a position at which a pole of a minimum jitter is obtained in addition to the process of FIG. 26;

FIG. 31 is a flow chart illustrating an example of execution for recording quality inspection before record;

FIG. 32 is a flow chart illustrating an example of execution for recording quality inspection after record;

FIG. 33 is a conceptual diagram illustrating an example in which a result of record reproduction in test recording does not satisfy a preset threshold;

FIG. 34 is a conceptual diagram illustrating an example in which a result of record reproduction in test recording does not satisfy a preset amount of margin;

FIG. 35 is a conceptual diagram illustrating an example in which a pulse margin satisfying a power margin α does not satisfy a preset amount ε;

FIG. 36 is a conceptual diagram illustrating an example in which a distance between an intersecting point of a jitter curve and a jitter threshold and an intersecting point of the jitter curve and a power upper bound is taken as a power margin;

FIG. 37 is a conceptual diagram illustrating an example in which a minimum jitter point is located at a power lower than a power upper bound, as the same case as FIG. 36;

FIG. 38 is a conceptual diagram illustrating an example in which a minimum jitter point is located at a power upper bound, as the same case as FIG. 36; and

FIG. 39 is a conceptual diagram illustrating an example in which a preset amount of margin is set from a power upper bound.

An optical-information recording apparatus according to an embodiment of the present invention will be described with reference to the drawings. The present invention can be accomplished in various ways including, but not limited to, the foregoing embodiments

FIG. 1 is a block diagram showing the overall construction of a recording system including a medium and a drive according to an embodiment of the present invention. Referring to FIG. 1, the recording system includes a drive 20 according to this embodiment, and a medium 16 for recording by the drive 20. The medium 16 can be an optical-information recording medium, for example, a dye-based medium such as a CD-R or DVD-R, or a phase-change medium such as a CD-RW or DVD-RW.

As shown in FIG. 1, the drive 20 includes a pickup 30 that forms an optical system for irradiating the medium 16 with laser beams, a servo detector 32 for detecting geometric information of a control position of the pickup 30, an RF detector 34 for detecting an RF signal obtained by the pickup 30, an LD controller 36 for controlling a laser diode provided in the pickup 30, a memory 38 storing control parameters of the LD controller 36 and a threshold that will be described later, and so forth, a tracking controller 40 that controls tracking of the pickup 30 based on the result of detection by the servo controller 32, and a focus controller 42 that controls focusing of the pickup 30.

The components of the drive 20 are well known to those skilled in the art, so that detailed descriptions thereof will be omitted herein.

Among the components, the LD controller 36 and the memory 38 particularly relate to testing of recording quality, which constitutes a main feature of this embodiment. The LD controller 36 outputs a parameter for a laser beam for irradiating the medium 16 therewith, i.e., recording pulses, to the pickup 30, thereby controlling recording condition. The memory 38 stores a pattern of recording pulses and other parameters.

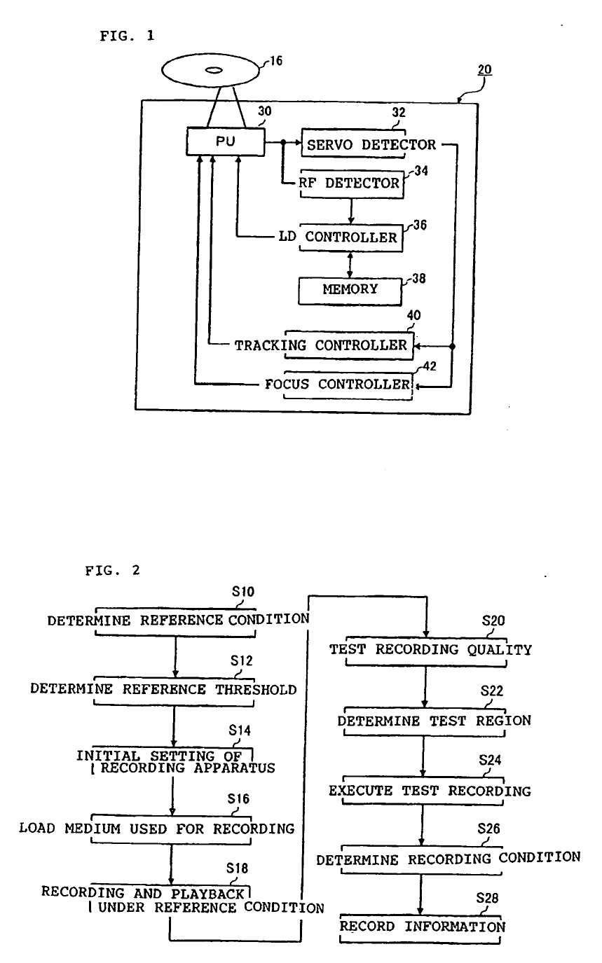

FIG. 2 is a flowchart showing a procedure that is executed by the drive 20 according to this embodiment. Referring to FIG. 2, the drive 20 executes steps S10 to S14 to make initial setting of the drive 20. Then, the drive 20 executes steps S16 to S22 to determine a condition for test recording. Then, the drive 20 executes step S24 to execute test recording under the condition determined. Then, the drive 20 executes step S26 to determine a condition for actual recording based on the result of the test recording. Then, the drive 20 executes step S28 to record information on the medium 16 under the condition determined. Now, these steps will be described in more detail.

Determining Reference Condition

In step S10 shown in FIG. 2, test recording is carried out while varying recording speed using a standard medium, thereby obtaining one pulse width and three power values as a reference condition. Preferably, the three power values are a power value that minimizes jitter as a result of the test recording, and two power values above and below that power value. Preferably, the two power values are values in the vicinity of a threshold that serves as a reference for determining a result of jitter test. These reference conditions are used for later testing of recording quality.

Determining Reference Threshold

As will be described later, it is supposed in this embodiment that a region where the jitter threshold is not exceeded is set as a range of test recording condition (hereinafter referred to as a “test region”), so that the jitter threshold that serves as a reference must be determined. The threshold may be a standard value determined in advance in accordance with the type of the drive or medium. However, the threshold representing a minimum line of an allowable region of jitter varies depending on the status of the pickup 30 or other components shown in FIG. 1, and also varies depending on the recording speed for the medium.

Thus, preferably, the threshold is also determined on the basis of a combination of a drive and a medium that are actually used so that a more appropriate reference will be used and a more appropriate test region will be set.

It is to be noted, however, that setting a threshold on the basis of a combination of a drive and a medium causes an increase in the number of recording steps. Thus, alternatively, a threshold that is suitable for an individual drive may be stored in the memory 38 at the time of manufacturing, assuming that variation among individual drives is a main factor of variation in the threshold.

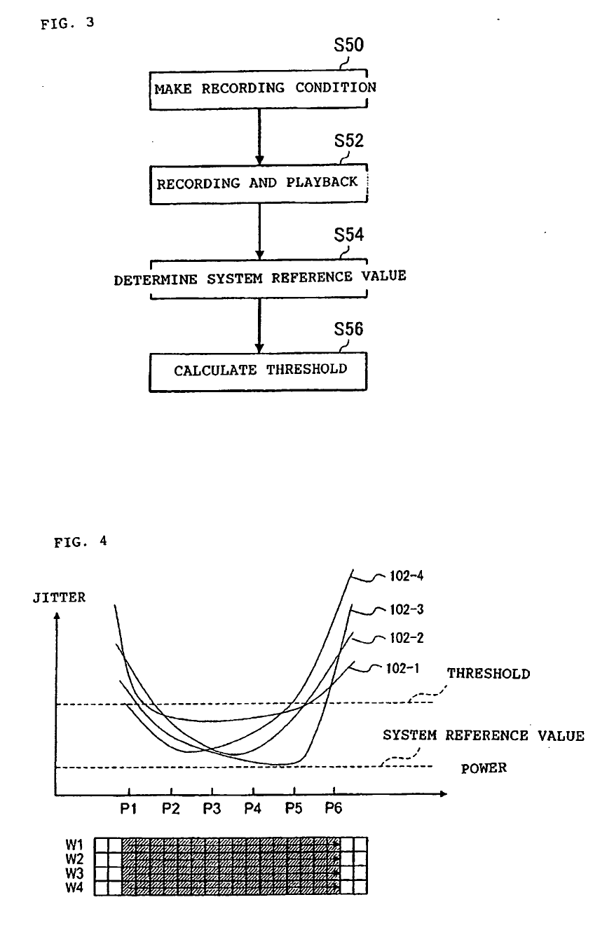

FIG. 3 is a flowchart showing details of the step of determining a reference threshold, shown in FIG. 2. Referring to FIG. 3, to determine a reference threshold, recording and playback are carried out based on a predetermined recording condition, a reference value for the system is determined based on the result, and a value obtained by setting a predetermined margin to the reference value is determined as a threshold that is used to determine a test region. Now, these steps will be described in order.

First, in step S50, a recording condition is set. In step S50, a predetermined number of patterns of conditions needed for recording and playback, such as a pulse width, power, recording and playback speed, and recording address, is prepared, and the recording conditions are set in the drive 20. Then, a reference medium is loaded in the drive 20. Preferably, a medium having standard characteristics among various media is chosen as the reference medium.

Then, in step S52, recording and playback are carried out with the reference medium loaded based on the recording conditions set in step S50, thereby obtaining recording and playback characteristic values under the respective recording conditions, such as jitter. A value representing recording quality is selected as the characteristic value to be obtained.

Then, in step S54, an optimal value, for example, a minimum value of jitter, is selected from the recording and playback characteristic values obtained in step S52. Here, a jitter value that is presumably approximate to the optimal value for the drive is set as a reference value. The reference value need not be an optimal point of jitter, and may be an intermediate point of two points crossing a predetermined threshold, i.e., an intermediate value of power margin.

Finally, in step S56, the system reference value determined in step S54 is multiplied by a predetermined coefficient α (preferably, α>1) to calculate a threshold. Here, a predetermined margin is provided with respect to the system reference value. That is, the threshold is calculated by multiplying the system reference value by α, where α is preferably about 1.5. The coefficient α is set suitably in accordance with the type of the drive or medium. The coefficient α may be set to 0.8 to 1.2 so that the threshold will be close to the system reference value, or to 2.0 to 3.0 so that the threshold will be larger.

FIG. 4 is a schematic diagram showing an example relating to the flow shown in FIG. 3. In the example shown in FIG. 4, a jitter value is used as a characteristic value representing recording quality, and the value of power is varied from P1 to P6 for each of pulse widths W1 to W4 to obtain playback characteristics 102-1 to 102-4. In the example shown in FIG. 4, the pulse widths W1 to W4 and the power P1 to P6 are used as recording conditions. The pole of the playback characteristics 102-3 that minimizes the jitter value is used as the system reference value, and a value obtained by multiplying the system reference value by, for example, 1.5 is used as a threshold. The arrows in the matrix image shown in FIG. 4 indicate directions of changing test conditions. This also applies to the subsequent figures.

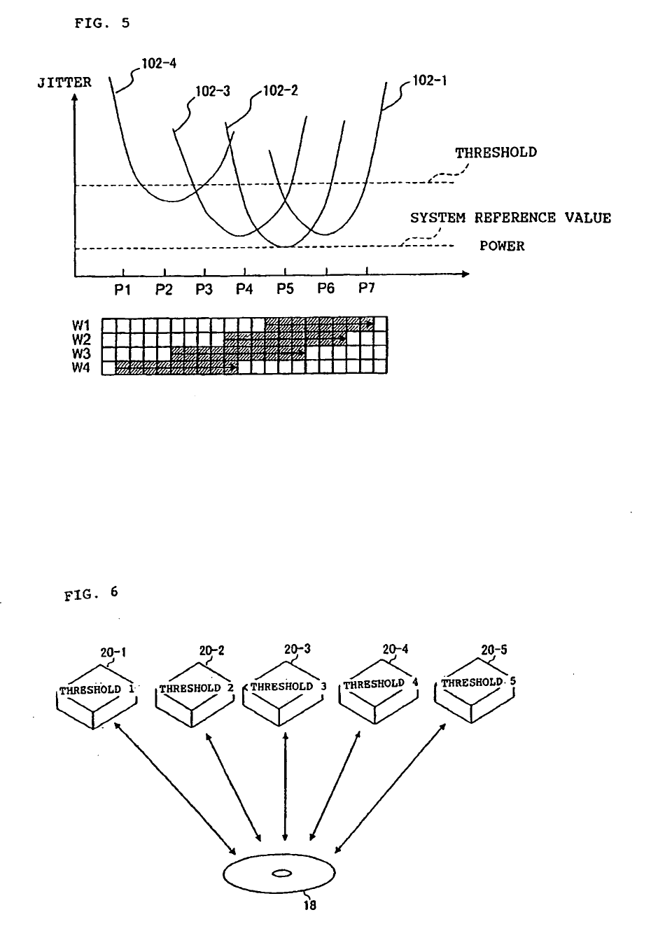

FIG. 5 is a schematic diagram showing an example relating to the flow shown in FIG. 3. In the example shown in FIG. 5, a jitter value is used as a characteristic value representing recording quality, and the range of variation in the power value is varied among the pulse widths W1 to W4 to obtain playback characteristics 102-1 to 102-4. In the example shown in FIG. 5, the pole of the playback characteristics 102-2 that minimizes the jitter value is used as the system reference value, and a value obtained by multiplying the system reference value by, for example, 1.5 is used as the threshold. As just described, a threshold may be determined while varying the power condition for each of the pulse widths.

FIG. 6 is a schematic diagram of an example where a threshold is calculated for each drive. When thresholds are preferred to be set in accordance with variation among individual drives, as shown in FIG. 6, recording and playback are carried out with a common reference medium 18 by drives 20-1 to 20-5, and thresholds 1 to 5 specific to the respective drives are stored.

FIG. 7 is a schematic diagram of an example where an average of thresholds calculated for several drives is used as thresholds for other drives. When it is desired to simplify steps of setting thresholds, as shown in FIG. 7, thresholds 1 to 5 are obtained by carrying out recording and playback with the common reference medium 18 using the standard drives 20-1 to 20-5, respectively, and taking an average of the thresholds 1 to 5. The average threshold is used as thresholds for other drives 20-6 to 20-10.

The drives 20-1 to 20-5 used to calculate an average threshold may be configured identically to each other, or similarly to each other. Furthermore, an average threshold may be used as thresholds for the drives 20-1 to 20-5. Furthermore, an average value once obtained may be used generally as thresholds for identically or similarly configured drives that are manufactured subsequently. Furthermore, it is possible to intentionally prepare a plurality of drives having variation and obtain an average threshold among the drives.

Initial Setting of Recording Apparatus

In step S14, the reference condition and the reference threshold obtained in steps S10 and S12 shown in FIG. 2 are stored in the memory 38 of the drive 20. Preferably, step S14 is executed at the time of manufacturing of the drive 20.

Loading of Recording Medium

Then, in step S16, the medium 16 for recording information thereon is loaded in the drive 20 where the initial setting has been completed in step S14.

Recording and Playback Under Reference Condition

Then, in step S18, recording is carried out on the medium 16 loaded in step S16, under the conditions set in step S14. More specifically, jitter values at three points are obtained by carrying out recording and playback three times using the single pulse width and three power values defined as reference conditions. The recording characteristics in relation to combinations of the drive 20 and the medium 16 can be understood by plotting the jitter values at the three points along a power axis.

Testing of Recording Quality

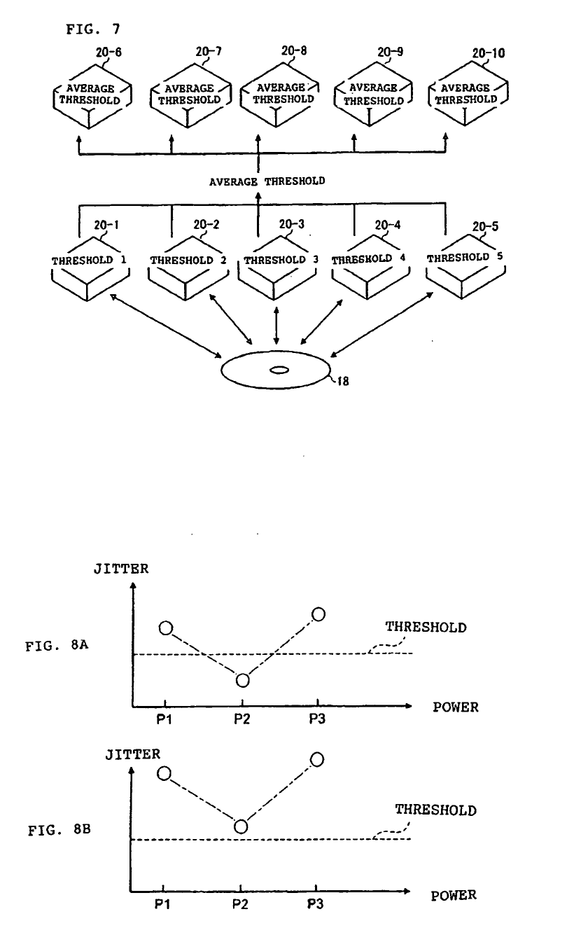

FIGS. 8A and 8B are schematic diagrams showing examples of valley patterns obtained as results of testing recording quality in step S20 shown in FIG. 2. As shown in FIGS. 8A and 8B, recording quality is tested using the jitter value and threshold for the respective reference conditions obtained in the preceding steps. In the examples shown in FIGS. 8A and 8B, power values P1, P2, and P3 are used as reference conditions, and a virtual line connecting jitter values obtained with the respective power values forms a valley pattern. When such a valley pattern is obtained, it is indicated that the reference medium used in step S10 and the recording medium loaded in step S16 have substantially the same sensitivity and similar recording characteristics.

FIG. 8A shows an example where the minimum value of the valley pattern is under the threshold than the threshold, and FIG. 8B shows an example where the minimum value of the valley pattern is not smaller than the threshold. Presumably, the reference medium and the recording medium have the same sensitivity in either case. When the reference medium and the recording medium have substantially the same sensitivity, a condition used for test recording is set by a surface area defined by power×pulse width and centered around the reference condition, as will be described later.

In FIGS. 8A and 8B, the difference between a playback value and a playback reference value obtained at each of the recording points P1, P2, and P3, i.e., the difference between the jitter value and the jitter threshold in the examples shown in FIGS. 8A and 8B, differs, and the playback value being closer to the playback reference value in FIG. 8A than in FIG. 8B.

This indicates that it is easier to find an optimal condition in the example shown in FIG. 8A than in the example shown in FIG. 8B. Thus, testing may be carried out a smaller number of times in the example shown in FIG. 8A than in the example shown in FIG. 8B, finding more optimal solution by a smaller number of tests.

That is, when the difference between the playback value and the playback reference value is small, the optimal condition becomes closer to the reference condition. On the other hand, when the difference between the playback value and the playback reference value is large, the optimal condition becomes remoter from the reference condition. Thus, when it is desired to decrease the number of times of testing, the number of times of testing is preferably varied in accordance with the difference between the playback value and the reference playback value.

FIGS. 9A and 9B are schematic diagrams showing examples where right-decreasing patterns are obtained as results of testing recording quality in step S20 shown in FIG. 2. In the examples shown in FIGS. 9A and 9B, right-decreasing patterns are obtained, where the jitter value decreases as the power increases through P1, P2, and P3. When such a right-decreasing pattern is obtained, it is indicated that the sensitivity of the recording medium is lower than the sensitivity of the reference medium.

FIG. 9A shows an example where the minimum value of the right-decreasing pattern is not larger than the threshold, and FIG. 9B shows an example where the minimum value of the right-decreasing pattern is not smaller than the threshold. It is presumed that the sensitivity of the recording medium is lower than the sensitivity of the reference medium in either case. When the sensitivity of the recording medium is lower, a test region defined by a surface area of power×pulse width and centered around the reference condition is shifted to the side of high power and wide pulse width for test recording, as will be described later.

Furthermore, when such a right-decreasing pattern shown in FIGS. 9A and 9B is obtained, the minimum value of jitter presumably exists on the side of higher power, so that additional writing may be performed at a power higher than P3 to check recording characteristics again. In this case, although the number of times of recording increases by one, the precision of testing of recording quality is improved. When such a pattern is obtained, similarly to the case where a valley pattern is obtained, the number of times of testing may be varied in accordance with the difference between the playback value and the playback reference value.

Furthermore, when such a right-decreasing pattern shown in FIGS. 9A and 9B is obtained, presumably, the optimal solution becomes remoter from the reference condition than in the valley patterns shown in FIGS. 8A and 8B, so that the number of times of testing is preferably increased than in the case of the valley patterns.

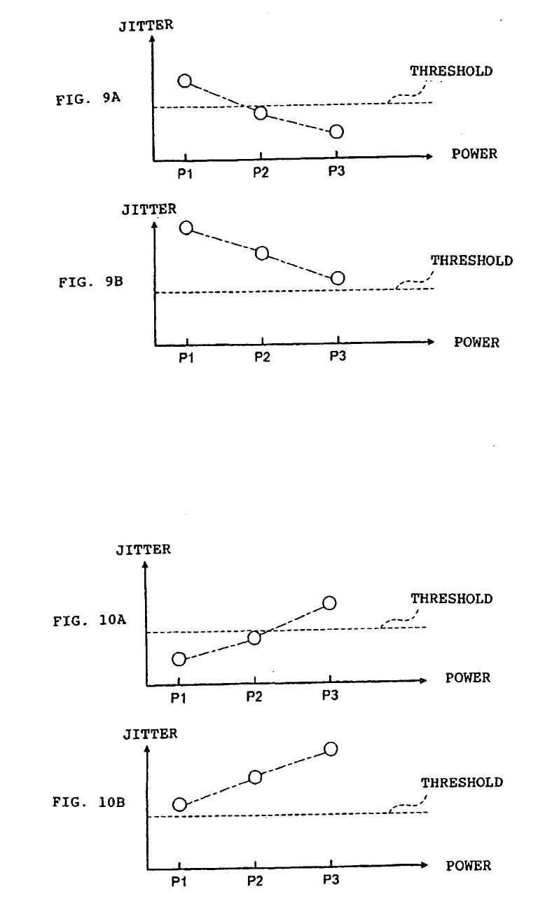

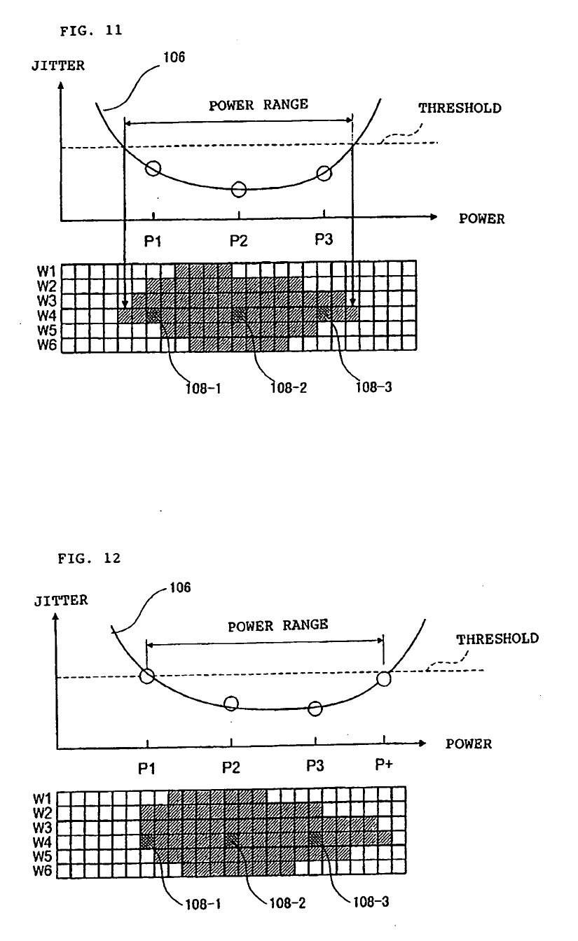

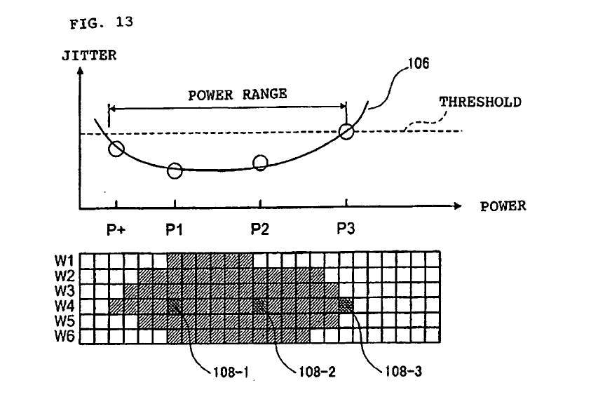

FIGS. 10A and 10B are schematic diagrams showing examples where right-increasing patterns are obtained as results of testing recording quality in step S20 shown in FIG. 2. In the examples shown in FIGS. 10A and 10B, right-increasing patterns are obtained where the jitter value increases as the power increases through P1, P2, and P3. When such right-increasing patterns are obtained, it is indicated that the sensitivity of the recording medium is higher than the sensitivity of the reference medium.

FIG. 10A shows an example where the minimum value of the right-increasing pattern is not larger than the threshold, and FIG. 10B shows an example where the minimum value of the right-increasing pattern is not smaller than the threshold. Presumably, the sensitivity of the recording medium is higher than the sensitivity of the reference medium in either case. When the sensitivity of the recording medium is higher, a test region defined by a surface area of power×pulse width and centered around the reference condition is shifted to the side of lower power and narrower pulse width for test recording, as will be described later.

Furthermore, when right-increasing patterns shown in FIGS. 10A and 10B are obtained, the minimum value of jitter presumably exists on the side of lower power, so that additional writing may be performed at a power lower than P1 to check recording characteristics again. In this case, although one additional recording is required, the precision of testing of recording quality is improved. When such patterns are obtained, similarly to the cases where the valley patterns are obtained, the number of times of testing may be varied in accordance with the difference between the playback value and the playback reference value.

Furthermore, when such right-increasing patterns shown in FIGS. 10A and 10B are obtained, presumably, the optimal solution becomes remoter from the reference condition than in the valley patterns shown in FIGS. 8A and 8B. Thus, preferably, the number of times of testing is increased compared with the case of the valley patterns.

Determining Test Region

FIG. 11 is a schematic diagram showing an example of determining a test region in step S22 when a valley pattern is obtained in step S20 shown in FIG. 2. As shown in FIG. 11, when a valley pattern is obtained, the power value for test recording is varied in a power range defined by intersecting points of the threshold and an approximated curve 106 drawn with jitter values obtained at P1, P2, and P3, respectively. In this embodiment, a “power range” is defined as a range of power that is actually used in test recording, and a “power margin” is defined as a range of power with which jitter does not exceed a threshold.

The approximated curve 106 differs depending on pulse width. Thus, denoting a pulse width used for the reference condition W4, recording is carried out at power values P1, P2, and P3 for each of the pulse widths W1 to W6 centered around W4. Intersecting points of the threshold are checked thereby and the approximated curve 106 is obtained. Thus, as represented in the matrix image shown in FIG. 11, a power range where jitter does not exceed the threshold is obtained for each of the pulse widths, and a hatched region shown in FIG. 11 is used as a test region. The three power conditions P1, P2, and P3 and the pulse width W4 correspond to 108-1, 108-2, and 108-3 in the matrix image shown in FIG. 11. The test region is set as a surface region defined by power×pulse width and centered around the reference condition.

By obtaining a power range for each pulse width as described above, a region where jitter does not exceed the threshold can be tested in a concentrated manner, so that a suitable condition can be found by a smaller number of times of testing.

The number of times of testing can also be reduced by setting a larger step size of variation in the power value when the power margin is large, or by setting a smaller step size of variation in the power value when the power margin is small. For example, when the power margin is 10 mW, assuming that rough testing suffices to obtain an optimal value, testing is carried out five times with a step size of 2 mW. When the power margin is 1 mW, assuming that more precise testing is needed, testing is carried out ten times with a step size of 0.1 mW.

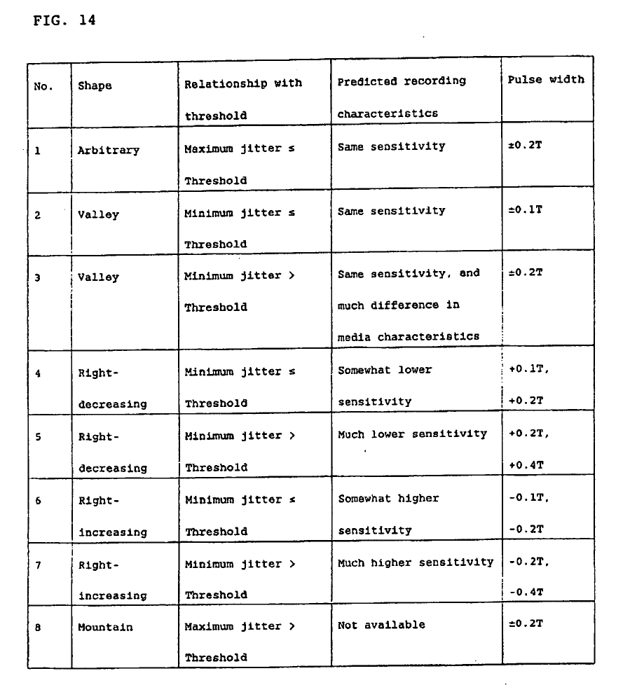

FIG. 12 is a schematic diagram showing an example of determining a test region in step S22 when a right-decreasing pattern is obtained in step S20 shown in FIG. 2. When a right-decreasing pattern is obtained, it is presumed that an optimal parameter exists on the side of higher power, as shown in FIG. 12. Thus, additional recording is performed at a power value P+ that is higher than P3, and a range defined by intersecting points of the threshold and the approximated curve 106 drawn with jitter values obtained at P1, P2, P3, and P+, respectively, is used as a power range. This processing is carried out for each of the pulse widths W1 to W6, obtaining a test region represented in the matrix image shown in FIG. 12.

The test region determined by the procedure described above correspond to the surface region defined by power×pulse width being shifted to the side of higher power and centered around the reference conditions 108-1, 108-2, and 108-3. Although W1 to W6 used for the valley pattern are used in this example, W1 to W6 may be shifted to a larger pulse width region to determine a power range since a right-decreasing pattern indicates a lower sensitivity.

FIG. 13 is a schematic diagram showing an example of determining a test region in step S22 when a right-increasing pattern is obtained in step S20 shown in FIG. 2. When a right-increasing pattern is obtained, it is presumed that an optimal parameter exists on the side of lower power, as shown in FIG. 13. Thus, additional recording is performed at a power value P+ that is lower than P1, and a power range is defined by intersecting points of the threshold and the approximated curve 106 drawn with jitter values obtained at P+, P1, P2, and P3, respectively. This processing is carried out for each of the pulse widths W1 to W6, obtaining a test region represented in the matrix image shown in FIG. 13.

The test region determined by the procedure described above correspond to the surface region defined by power×pulse width being shifted to the side of higher and centered around the reference conditions 108-1, 108-2, and 108-3. Although W1 to W6 used for the valley pattern are used in this example, W1 to W6 may be shifted to a narrower pulse width range to determine a power range since a right-increasing pattern indicates a higher sensitivity.

That is, according to the method described above, recording quality is tested for each pulse width, and the number of times of testing is determined for each pulse width according to results of the testing. Thus, the number of times of testing can be reduced. The testing of recording quality, described above, is an example where change in jitter is patterned by recording at the reference condition. Preferably, the following eight patterns are used.

FIG. 14 is a diagram showing an example of performing step S20 shown in FIG. 2 using eight patterns. Referring to FIG. 14, The pattern 1 is applied when the maximum value of jitter does not exceed the threshold, regardless of whether the pattern is a valley, right-increasing, or right-decreasing. When this pattern is obtained, it is considered that the sensitivity of the recording medium is substantially the same as the sensitivity of the reference medium and that a large margin where the jitter value does not exceed the threshold is provided, so that the power condition is extended on both lower power side and higher power side. That is, with the pattern 1, since values in the vicinity of the threshold are not obtained, additional recording is carried out on both the lower power side and the higher power side.

Then, jitter characteristics obtained by the additional recording are approximated by a curve, and the range between two values, large and small, at which the curve intersect with the jitter threshold is used as a reference value of power range.

Furthermore, when this pattern is obtained, a pulse width region of the reference value ±0.2 T is determined as a test region. In test recording, an optimal recording condition is determined by varying the pulse width by a step size of 0.2 T. T denotes the length of a time unit of a recording pit.

Here, assume that the reference pulse width is a pulse condition 1, and the extended two points are pulse conditions 2 and 3, the pulse conditions 2 and 3 for the pattern 1 are pulse widths extended by ±0.2 T. In accordance with the change in the pulse width condition, the power range used as a test condition is also adjusted.

More specifically, when the pulse width is changed by 0.1 T, the power range for the pulse width is defined as the reference value of power range×(1-0.05×1) mW. When the pulse width is changed by 0.2 T, the power range for the pulse width is defined as the reference value of power range×(1−0.05×2) mW. When the pulse width is changed by −0.1 T, the power range for the pulse width is defined as the reference value of power range×(1−0.05×(−1)) mW.

Thus, the following three patterns of test conditions are used for the pattern 1.
(1) Reference value of pulse width, and reference value of power range
(2) Reference value of pulse width −0.2 T, and reference value of power range×(1−0.05×(−2)) mW
(3) Reference value of pulse width +0.2 T, and reference value of power range×(1−0.05×(+2)) mW

In this embodiment, the reference condition (1) need not be used in actual test recording.

The pattern 2 is applied when a valley pattern is obtained and the minimum value of jitter does not exceed the threshold. When this pattern is obtained, it is considered that the sensitivity of the medium on which data is to be recorded and the sensitivity of the reference medium are substantially the same, so that reference value ±0.1 T is selected as a pulse width condition. Then, a power range is set for each of these pulse conditions by the same procedure used for the pattern 1. Thus, the following three patterns of test conditions are used for the pattern 2.
(1) Reference value of pulse width, and reference value of power range
(2) Reference value of pulse width −0.1 T, reference value of power range×(1−0.05×(−1)) mW
(3) Reference value of pulse width +0.1 T, reference value of power range×(1−0.05×(+1)) mW

The pattern 3 is applied when a valley pattern is obtained and the minimum value of jitter exceeds the threshold. When this pattern is obtained, it is considered that the sensitivity of the medium on which data is to be recorded is substantially the same as the sensitivity of the reference media, and that difference in the characteristics of medium is large, so that reference value ±0.2 T is selected as a pulse width condition. Then, a power range is set for each of these pulse conditions by the same procedure as for the pattern 1. Thus, the following three patterns of test conditions are used for the pattern 3.
(1) Reference value of pulse width, and reference value of power range
(2) Reference value of pulse width −0.2 T, and reference value of power range×(1−0.05×(−2)) mW
(3) Reference value of pulse width +0.2 T, and reference value of power range×(1−0.05×(+2)) mW

The pattern 4 is applied when a right-decreasing pattern is obtained and the minimum value of jitter does not exceed the threshold. When this pattern is obtained, it is considered that the sensitivity of the recording medium is slightly lower than the sensitivity of the reference medium, so that three points, the reference value, +0.1 T, and +0.2 T, are selected as pulse width conditions. Then, a power range is set for each of these pulse conditions by the same procedure used for the pattern 1. Thus, the following three patterns of test conditions are used for the pattern 4.
(1) Reference value of pulse width, and reference value of power range
(2) Reference value of pulse width +0.1 T, and reference value of power range×(1−0.05×(+1)) mW
(3) Reference value of pulse width +0.2 T, and reference value of power range×(1−0.05×(+2)) mW

The pattern 5 is applied when a right-decreasing pattern is obtained and the minimum value of jitter exceeds the threshold. When this pattern is obtained, it is considered that the sensitivity of the recording medium is significantly lower than the sensitivity of the reference medium, so that three points, the reference value, +0.2 T, and +0.4 T, are selected as pulse width conditions. Then, a power range is set for each of these pulse conditions. Thus, the following three patterns of test conditions are used for the pattern 5.
(1) Reference value of pulse width, and reference value of power range
(2) Reference value of pulse width +0.2 T, and reference value of power range×(1−0.05×(+2)) mW
(3) Reference value of pulse width +0.4 T, and reference value of power range×(1−0.05×(+4)) mW

The pattern 6 is applied when a right-increasing pattern is obtained and the minimum value of jitter does not exceed the threshold. When this pattern is obtained, it is considered that the sensitivity of the recording medium is slightly higher than the sensitivity of the reference medium, so that three points, the reference value, −0.1 T, and −0.2 T, are selected as pulse width conditions. Then, a power range is set for each of these pulse conditions by the same procedure used for the pattern 1. Thus, the following three patterns of test conditions are used for the pattern 6.
(1) Reference value of pulse width, and reference value of power range
(2) Reference value of pulse width −0.1 T, and reference value of power range×(1−0.05×(−1)) mW
(3) Reference value of pulse width −0.2 T; and reference value of power range×(1−0.05×(−2)) mW

The pattern 7 is applied when a right-increasing pattern is obtained and the minimum value of jitter exceeds the threshold. When this pattern is obtained, it is considered that the sensitivity of the recording medium is significantly larger than the sensitivity of the reference medium, so that three points, the reference value, −0.2 T, and −0.4 T, are selected as pulse width conditions. Then, a power range is set for each of these pulse width conditions by the same procedure used for the pattern 1. Thus, the following three patterns of test conditions are used for the pattern 7.
(1) Reference value of pulse width, and reference value of power range
(2) Reference value of pulse width −0.2 T, and reference value of power range×(1−0.05×(−2)) mW
(3) Reference value of pulse width −0.4 T, and reference value of power range×(1−0.05×(−4)) mW

The pattern 8 is applied when a mountain pattern is obtained and the maximum value of jitter exceeds the threshold. When this pattern is obtained, it is considered that the pattern is abnormal, so that the reference value ±0.2 T are selected as pulse-width conditions. Then, a power range is set for each of these pulse width conditions by the same procedure used for the pattern 1. Thus, the following three patterns of test conditions are used for the pattern 8.
(1) Reference value of pulse width, and reference value of power range
(2) Reference value of pulse width −0.2 T, and reference value of power range×(1−0.05×(−2)) mW
(3) Reference value of pulse width +0.2 T, and reference value of power range×(1−0.05×(+2)) mW

Of the eight patterns described above, when patterns other than the pattern 2, which is most approximate to the reference medium, are detected, and the recording result that has caused the pattern may be played back again to detect jitter in order to confirm that the pattern detected is not due to an incorrect playback operation. In this case, when characteristics other than the pattern 2 are detected, recording conditions are added or extended according to the conditions shown in FIG. 14.

When the pattern 8 is detected by the confirmation of an incorrect playback operation, it may due to an incorrect recording operation. Thus, recording is performed again at the reference value of pulse width before performing additional recording and extending pulse width. When the pattern 8 is again obtained by the recording, additional recording, i.e., extending power to measure a margin for the pulse condition 1, may not carried out, and pulse conditions 2 and 3 are extended. The power value is extended in accordance with the extension of the pulse conditions 2 and 3 by the method described earlier.

That is, in the case of the pattern 8, a margin is not provided with the pulse condition 1 and a power range serves as a reference for extension is not obtained, so that an initial power condition range is set as a reference power range.

Determining Test Region: Determining Power Range by Approximation

By executing the procedure described above, a test region that is effective for obtaining an optimal solution with a small number of times of testing is determined. A method of determining a power range is described below, which is important in determining a test region, will be described.

In this embodiment, in order to improve the accuracy of finding an optimal solution by a smaller number of times of testing, test conditions are concentrated to a region where the jitter value does not exceed the threshold, as described earlier. According to this scheme, a power range that is used in test recording is calculated from power values at large and small points defining a margin with respect to the threshold. The margin with respect to the threshold refers to a region where characteristic values not exceeding the threshold are obtained. The power values at large and small points refer to a value on the lower power side and a value on the higher power side defining the width of the margin.

Considering the reduction in test recording time of various media and the efficiency of test region of a medium with restriction on a test recording region, such as a write-once medium, the number of recording points needed for test recording should preferably be minimized. However, since the power range to be obtained here is an important parameter that serves as a criterion for determining an optimal recording condition, a high precision is desired.

A precise determination of a power range means concentrated testing of a selected region, so that it contributes to a reduction in the number of times of testing. For example, when test recording is performed at a frequency of once per 0.1 mW, test recording is performed ten times when the power range is 1 mW, and test recording is performed twenty times when the power range is 2 mW. Thus, narrowing the power range contributes to a reduction in the number of times of testing.

Thus, in this embodiment, considering that the recording quality of recording and playback signals changes like a quadratic curve with a pole at an optimal point with respect to recording power, characteristic curve is approximated using several recording points to determine an amount of margin. By using such an approximation method, it is possible to readily and precisely determine a power range based on several recording points, serving to reduce the number of times of testing.

FIG. 15 is a schematic diagram for explaining a method of obtaining a power range used in step S22 shown in FIG. 2 by curve approximation. As shown in FIG. 15, to carry out approximation, first, two points a and c on the lower power side and the higher power side, respectively, at which the jitter value that serves as a criterion for determining recording characteristics is in the vicinity of the threshold, and a point b between the points a and c, at which the jitter value is smaller than the threshold and the values at the points a and c, are selected. That is, the points a, b, and c have the following relationship.
a>b, c>b, threshold>b

As shown in FIG. 15, the vicinity of the threshold is defined as a range between an upper limit and a lower limit having a certain width with respect to the threshold. Preferably, the upper limit is set to 40% of the threshold, and the lower limit is set to 5% of the threshold. Then, the values of a, b, and c are approximated by a quadratic function, and a power range is defined by the difference between large and small points where the quadratic curve intersects with the threshold. The range that is defined as the vicinity of the threshold may be changed suitably in consideration of the interval of recording points, for example, to −5% to +40% or −10% to 30%.

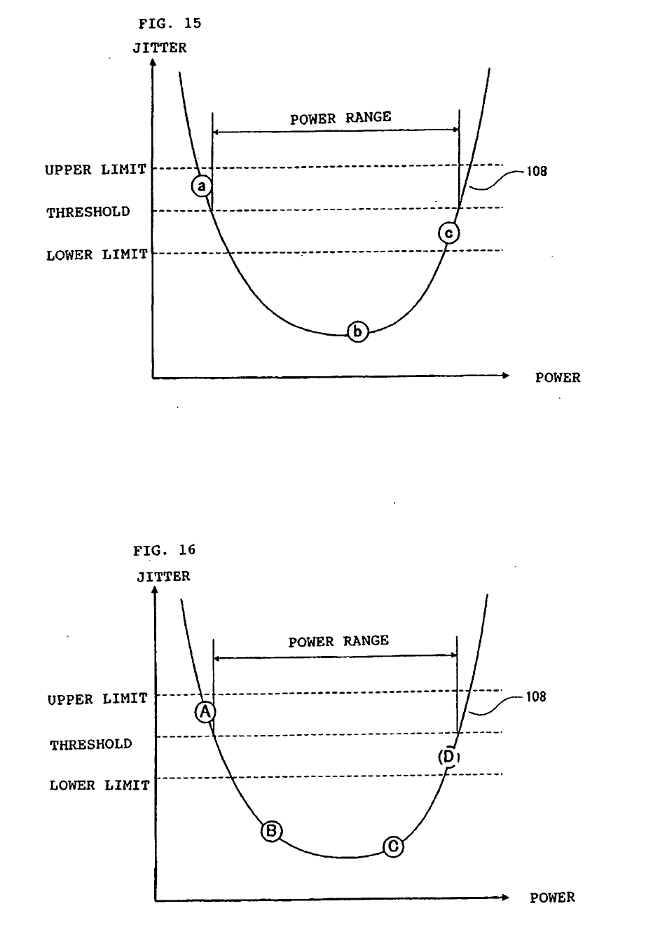

FIG. 16 is a schematic diagram for explaining another example where a power range used in step S22 shown in FIG. 2 is obtained by a curve approximation. As shown in FIG. 16, when a relationship satisfying a>b, c>b, and threshold>b is not obtained with the three conditions A, B, and C alone, preferably, D at the higher power side is added to obtain a value in the vicinity of the threshold.

Furthermore, as shown in FIG. 16, when a relationship of B>C exists, preferably, an approximate equation is calculated with three points A, C, and D without using B.

The relationship between the three recording points and the threshold in this case is A>C, D>C, and threshold>C, which is suitable for drawing an approximated curve, so that a precise approximated curve is obtained by three-point approximation. The additional recording condition indicated by D is determined according to A>B, B>C, and the threshold indicated by recording points before the addition.

In contrast with FIG. 15, when a value in the vicinity of the threshold is absent on the low power side, additional recording is performed at a power condition lower than A. Depending on the relationship between the recording points and the threshold, one or more recording conditions may be added.

Furthermore, the range of power for additional recording conditions may be constantly varied by a predetermined power step size, or power conditions may be set based on relationship between power variation and jitter variation obtained in advance.

When recording points sufficient to obtain a power range are not obtained even after adding recording conditions as described above, recording points are changed by adding recording conditions again by the same procedure described above.

Furthermore, in a case of medium whose test recording region is restricted, such as a write-once medium, or in order to avoid using an enormous testing time, an upper limit may be set to the number of times recording conditions are added. Furthermore, an upper limit of power for additional recording may be set so that recording power will not exceed a laser output value by adding recording conditions.

Furthermore, although a power range is determined by three-point approximation in the example described above, alternatively, a power range may be determined based on the difference between power values at large and small points that are most approximate to the threshold.

Alternatively, two points in the vicinity of the threshold may be selected by performing recording while changing power until large and small points across the threshold are found, and two points that are most approximate to the threshold may be selected, or the two points themselves may be selected. The methods will be described below in more detail.

Determining Test Region: Determining Power Range by Sampling

FIG. 17 is a schematic diagram showing an example where a power range used in step S22 shown in FIG. 2 is determined by sampling. In the example shown in FIG. 17, instead of the three-point approximation described earlier, power is gradually changed until values approximate to the threshold is obtained. A power range is determined based on power values at large and small points in the vicinity of the threshold.

More specifically, as shown in FIG. 17, recording power is increased sequentially as P1, P2, P3, . . . to carry out recording and playback until a power value P6 at which a value larger than the threshold is obtained. As shown in a matrix image in FIG. 17, power is changed over P1 to P6, and a power range is set between P2 on the low power side and P6 on the high power side that are most approximate to the threshold. As just above, a power range can be determined by selecting two points that cross the threshold.

A method for selecting large and small points in the vicinity of the threshold can be selected from the following accordingly.

(1) Select large and small points defining a power margin. That is, select two points that are most approximate to a playback reference value within a power range satisfying the playback reference value.

(2) Select two points that are most approximate to a playback reference value although being slightly outside of a power margin.

(3) Select two points crossing a playback reference value on the low power side.

(4) Select two points crossing a playback reference value on the high power side.

(5) Select two points that are most approximate to a playback reference value and that are located across the playback reference value on the low power side and the high power side.

It is also possible to approximate recording characteristics using two points selected by one of the above methods, to determine large and small points that cross the playback reference value.

Test Recording

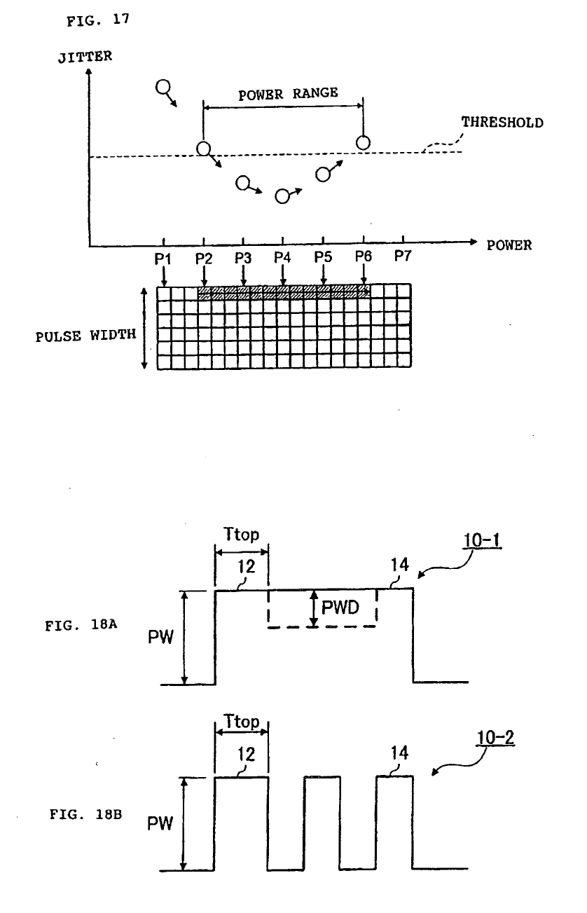

FIGS. 18A and 18B are schematic diagrams showing examples of pulse pattern used in test recording in step S24 shown in FIG. 2. FIG. 18A shows an example where a single pulse pattern is used. FIG. 18B shows an example where a multiple-pulse pattern is used. As shown in FIGS. 18A and 18B, each of a single-pulse pattern 10-1 and a multiple-pulse pattern 10-2 include a leading pulse 12 at the beginning of the pattern and a trailing pulse 14 at the end of the pattern. The amount of energy of the entire recording pulse is defined by the height of main power PW, and the amount of energy at the first stage applied to an edge of a recording pit is defined by the length of the leading pulse width Ttop. PWD indicated by a dotted line is an area used for fine adjustment of the amount of energy, and will be described later.

Preferably, the main power PW has a highest value in the recording pulses 10-1 and 10-2. The leading pulse width Ttop has a width corresponding to a recording pit having a length of 3 T. Since recording pulses having this width have the highest frequency of occurrence and has much effect on recording quality, preferably, the leading pulse width Ttop is varied in test recording.

As shown in FIGS. 18A and 18B, whether the single-pulse pattern or the multiple-pulse pattern is used, the value of test power determined by the preceding steps is used as the main power PW, and the width of the test pulse is used as the leading pulse width Ttop.

As described above, test recording is carried out with the medium loaded in step S16 shown in FIG. 2 while changing the main power PW and the leading pulse width Ttop stepwise, playback is carried out based on recording pits formed by the test recording to obtain a jitter value for each test condition.

Then, another test recording is carried out once more using a predetermined pattern of pits and lands to examine other factors such as mismatch between recording pulses and recording pits. Then, the series of test recording is finished.

Determination of Recording Condition

Through the test recording described above, values of the main power PW and the leading pulse width Ttop with which the jitter value is minimized, and parameters for adjusting other factors are determined, and these values are used as a recording condition suitable for the combination of the drive and the medium.

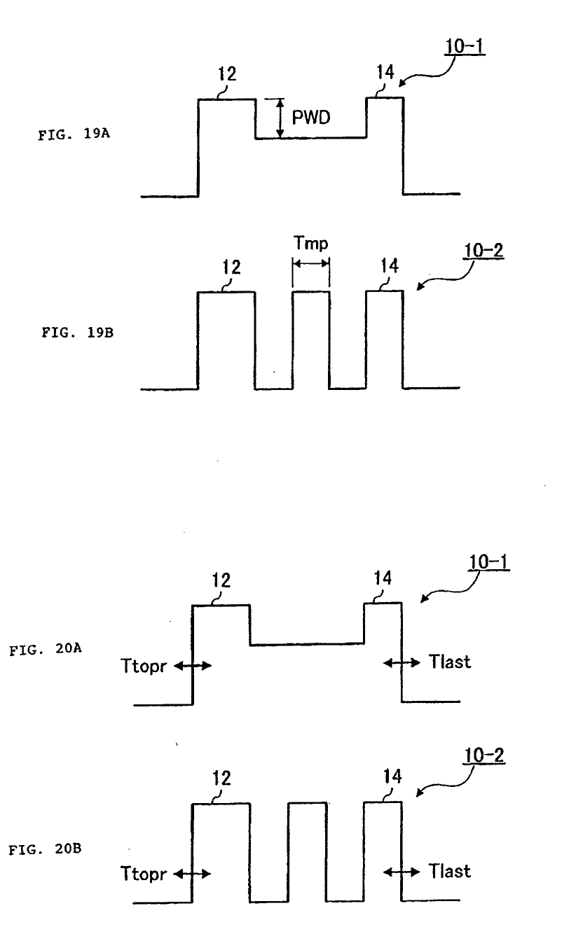

FIGS. 19A and 19B are schematic diagrams showing examples of adjustment of other factors determined in step S26 shown in FIG. 2. FIG. 19A shows an example where a single-pulse pattern is used. FIG. 19B shows an example where a multiple-pulse pattern is used.

As shown in FIG. 19A, in the case of the single-pulse pattern 10-1, a region of low power that is lower than the main power PW by PWD is provided between the leading pulse 12 and the trailing pulse 14 as another adjusting factor. By defining this amount, recording pits are prevented from forming a teardrop shape. Similarly, in the case of the multiple-pulse pattern 10-2, as shown in FIG. 19B, by defining the width Tmp of an intermediate pulse between the leading pulse 12 and the trailing pulse 14, recording pits are prevented from forming a teardrop shape.

FIGS. 20A and 20B are schematic diagrams showing examples of other factors to be adjusted, determined in step S26 shown in FIG. 2. Similarly to FIGS. 18A and 18B, FIG. 20A shows an example where a single-pulse pattern is used, and FIG. 20B shows an example where a multiple-pulse pattern is used.

As shown in FIGS. 20A and 20B, whether the single-pulse pattern 10-1 or the multiple-pulse pattern 10-2 is used, Ttopr for adjusting the starting position of the leading pulse 12, and Tlast for adjusting the ending position of the trailing pulse 14 are set as other factors to be adjusted. By adjusting these values, a pulse pattern with which a pit length after recording has an appropriate value is selected.

The main power PW, the leading pulse width Ttop, the low power region PWD, the leading pulse position Ttopr, and the trailing pulse position Tlast, obtained by the procedure described above, are stored in the memory 38 shown in FIG. 1 to finish the determination of recording condition.

Recording of Information

The LD controller 36 shown in FIG. 1 generates recording pulses based on various recording conditions stored in the memory 38 for information to be recorded input to the drive 20, and outputs the recording pulses to the pickup 30. Thus, the information is recorded on the medium 16.

Another Embodiment of Determination of Test Region

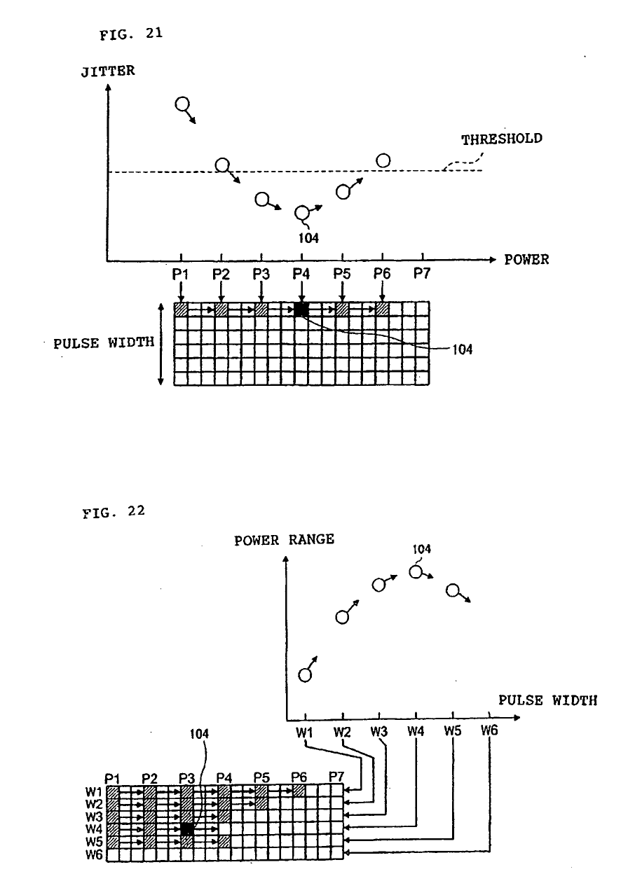

FIG. 21 is a schematic diagram showing an example where the test region extends up to a point where the jitter value exceeds the threshold. In the example shown in FIG. 21, the power used in test recording is varied from P1, P2, . . . to P6, and the test is finished at P6 where the jitter value exceeds the threshold. As represented in an image matrix, the power is discretely changed from P1, P2, . . . to P6 for a pulse width, and the power value P4 that minimizes the jitter value is used as a recording condition 104. In this case, the power range is defined by P1 to P6 over which the power is varied, and a range of P2 to P6 that is close to the region where the threshold is not exceeded serves as a power margin. As just described, the test region is extended up to a point where the threshold is reached, so that the number of times of testing is reduced compared with a case where testing is carried out over a constant power range.

FIG. 22 is a schematic diagram showing an example where a test region extends up to a point where a pole of power range is obtained. In the example shown in FIG. 22, in addition to the procedure of the example shown in FIG. 21, pulse width is varied, and the poles of power range or power margin obtained for the respective pulse widths are used as recording conditions. In this example, while sequentially changing pulse width as W1, W2, . . . , power is changed for each of the pulse widths up to a point where the threshold is reached as shown in FIG. 21, and this step is repeated until a pulse width W4 that maximizes power range or power margin is identified.

The pole of power range or power margin can be identified by examining the amount of change between values of adjacent sample points. Thus, when the pulse width W4 is a pole, test recording is carried out up to the subsequent pulse width W5. The power range and power margin differ among each pulse widths, so that the hatched region that are tested differs depending on the pulse width.

When the pulse width W4 is a pole, the pulse width W4 and a power P3 that minimizes the jitter value for the pulse width W4 are used as a recording condition 104. As just described, by changing the pulse width in addition to the procedure of the example shown in FIG. 21, the test region can be extended in the direction of pulse width with a small number of times of testing.

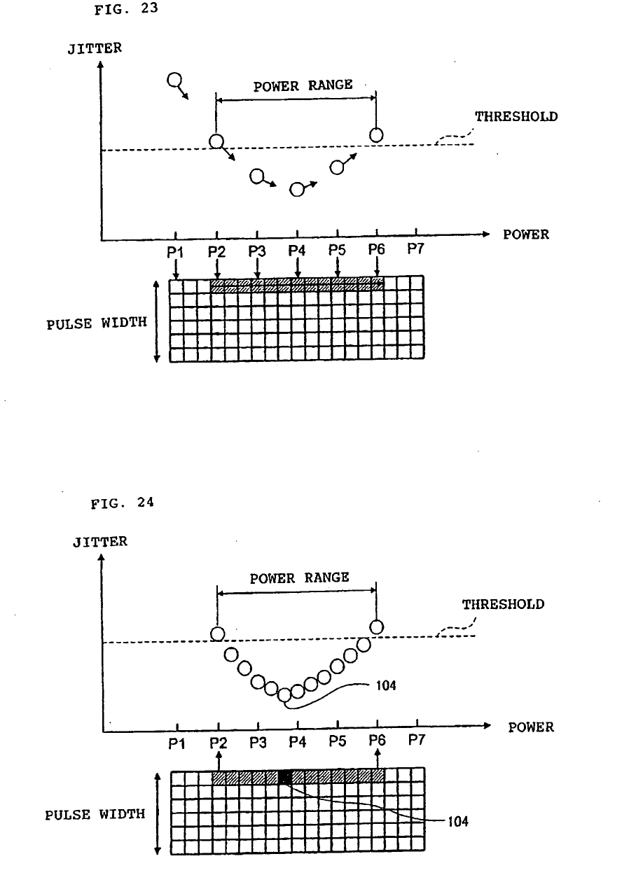

FIG. 23 is a schematic diagram showing an example where a power range is defined by two points in the vicinity of the threshold. In the example shown in FIG. 23, the power value is gradually changed until a value in the vicinity of the threshold is obtained, and a power range is determined based on large and small power values in the vicinity of the threshold. The procedure for this example is the same as that in the example shown in FIG. 17, so that a description thereof will be omitted.

This example differs from the example shown in FIG. 21 in that instead of testing sampling points between P2 and P6 alone, after determining a power range, the power is varied by a smaller step size over the range to determine a more suitable condition.

FIG. 24 is a schematic diagram showing an example where the power value is varied by a smaller step size over the power range. As shown in FIG. 24, the power value is varied by a smaller step size over the power range P2 to P6, and a power value that minimizes the jitter value is used as a recording condition 104. As just described, by examining the power range by a smaller step size, a value approximate to an optimal value is obtained. In this example, an optimal point is found between P3 and P4.

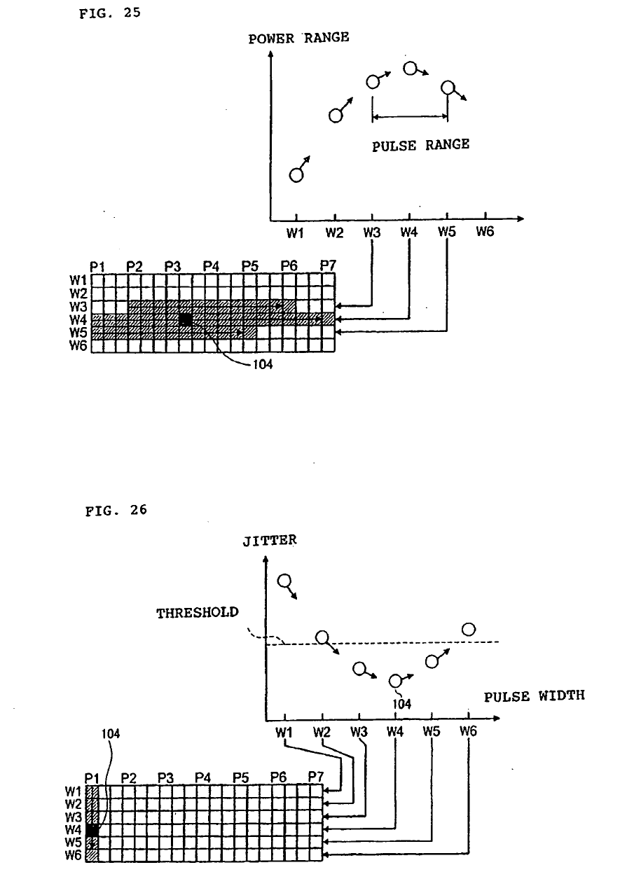

FIG. 25 is a schematic diagram showing an example where a test region extends up to a point where a pole of power range is obtained in addition to the procedure of the example shown in FIG. 24. In the example shown in FIG. 25, the pulse width is varied in addition to the procedure of the example shown in FIG. 24, and a pole of power range or power margin obtained for each pulse width is used as a recording condition. This scheme is the same as the scheme of applying the procedure of the example shown in FIG. 21 to the example shown in FIG. 22, so that a description thereof will be omitted.

FIG. 26 is a schematic diagram showing an example where the pulse width is changed up to a point where the jitter value exceeds the threshold, and the range of changing the pulse width is used as a test region. In the example shown in FIG. 26, the pulse width used for test recording is sequentially changed as W1, W2, . . . , and the test recording is finished at W6 at which the jitter value exceeds the threshold. As represented by an image matrix, the pulse width is sequentially changed as W1, W2, . . . W6 for the power P1, and the pulse width W4 that minimizes the jitter value among W1 to W6 is used as a recording condition 104. In this case, the pulse range to be tested is W1 to W6 over which the pulse width is varied, and the pulse margin is W2 to W6 that is close to a region where the jitter value does not exceed the threshold. As just described, by using a test region up to a point where the jitter value reaches the threshold, the number of times of testing is reduced compared with a case where a fixed pulse range is always used for testing.

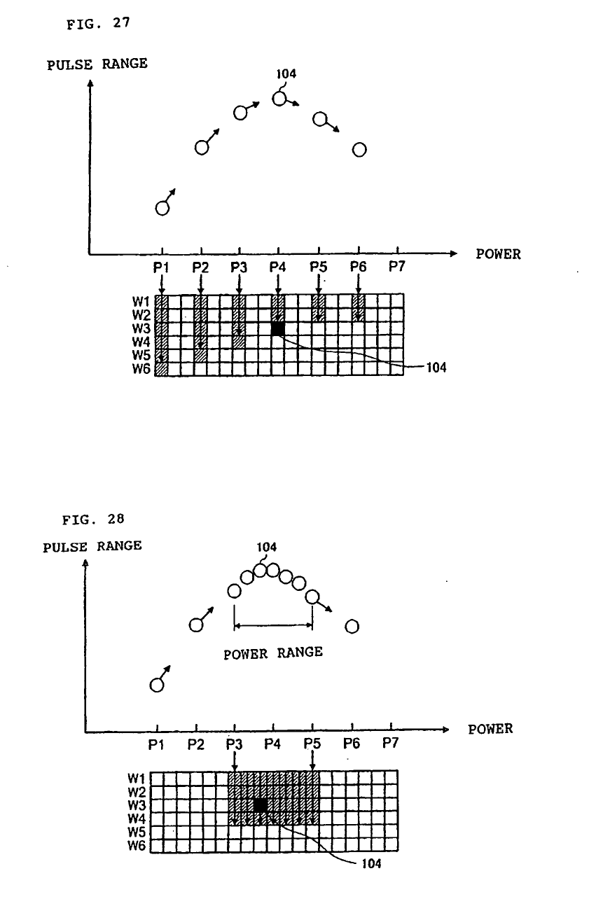

FIG. 27 is a schematic diagram where the test region extends up to a point where a pole of pulse range is obtained. In the example shown in FIG. 27, in addition to the procedure of the example shown in FIG. 26, the power value is varied and a pole of pulse range or pulse margin determined for each power value is used as a recording condition. In this example, while sequentially changing the power value as P1, P2, . . . , the pulse width is changed for each power value until the jitter value reaches the threshold shown in FIG. 26, and this step is repeated until power P4 that maximizes the pulse range or pulse margin is identified.

The pole of pulse range or pulse margin can be identified by examining the amount of change between values at adjacent sample points. Thus, when the power P4 is a pole, test recording is carried out up to the subsequent power P5. Since the pulse range and pulse margin differ depending on the power value, the hatched region to be tested differs depending on the power value, as represented in the matrix image shown in FIG. 27.

When the power P4 is a pole, the power P4 and the pulse width W3 that minimizes the jitter value for the power P4 are used as recording condition 104. As just described, by varying the power value in addition to the procedure of the example shown in FIG. 26, the test region can be extended in the direction of power with a small number of times of testing.

FIG. 28 is a schematic diagram showing an example where the power value is varied over the pulse range by a smaller step size. As shown in FIG. 28, the power value is varied by a smaller step size over P3 to P5 in the vicinity of the pole of the pulse range identified in FIG. 27, and a condition that minimizes the jitter value is used as a recording condition 104. As just described, by varying the power value in the vicinity of the pole by a smaller step size, a value approximate to an optimal value can be found. In this example, an optimal point is found between P3 and P4.

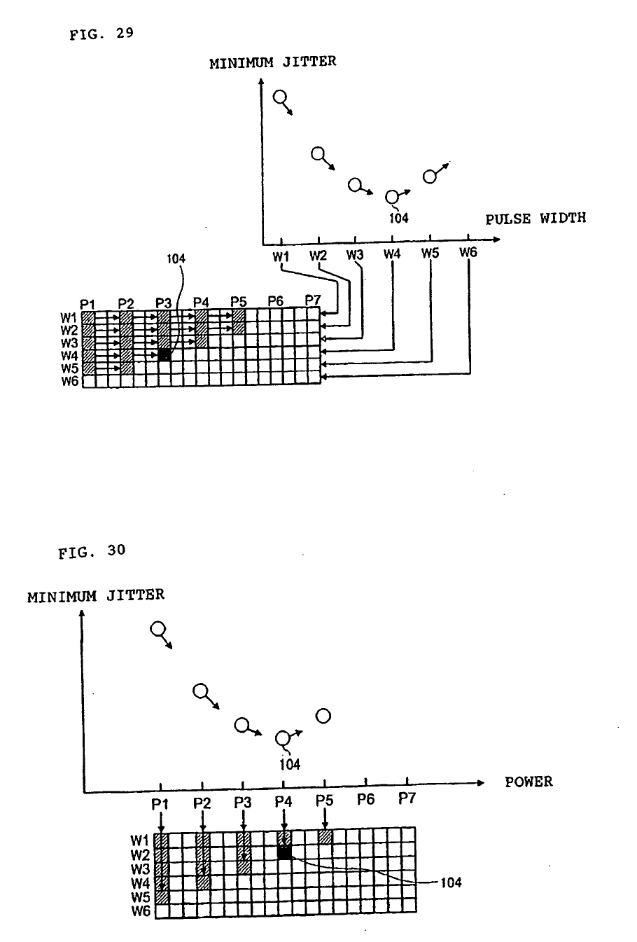

FIG. 29 is a schematic diagram showing an example where the test region extends up to a point where the pole of minimum jitter is obtained, in addition to the procedure of the example shown in FIG. 21. In the example shown in FIG. 29, in addition to the procedure of the example shown in FIG. 21, the pulse width is varied and the pole of minimum jitter determined for each pulse width is used as a recording condition. In this example, the pulse width is sequentially changed as W1, W2, . . . , and the procedure shown in FIG. 21 is executed for each of the pulse widths. While comparing the minimum jitter values thereby obtained, this step is repeated until a pulse width W4 that minimizes the jitter value is identified.

The pole of minimum jitter value can be identified by examining the amount of change between values at adjacent sample points. Thus, when the pulse width W4 is a pole, test recording is carried out up to the subsequent pulse with W5. Since the minimum jitter value differs depending on the pulse width, the hatched region that is tested differs depending on the pulse width, as represented in the matrix image shown in FIG. 29.

When the pulse width W4 is a pole, the pulse width W4 and a power P3 that minimizes the jitter value for the pulse width W4 are used as a recording condition 104. As just described, by detecting a pole of the minimum jitter value in addition to the procedure of the example shown in FIG. 21, the test region can be extended in the direction of pulse width with a small number of times of testing.

FIG. 30 is a schematic diagram showing an example where the test region extends up to a point where a pole of minimum jitter value is obtained, in addition to the procedure of the example shown in FIG. 26. In the example shown in FIG. 30, in addition to the procedure of the example shown in FIG. 26, power is varied and a pole of minimum jitter value determined for each power value is used as a recording condition. In this example, the power value is sequentially changed as P1, P2, . . . , and the procedure of the example shown in FIG. 26 is executed for each of the power values. While comparing the minimum jitter values thereby obtained, this step is repeated until a power P4 that minimizes the jitter value is identified.

The pole of minimum jitter value can be identified by examining the amount of change between values at adjacent sample points. Thus, when the power P4 is a pole, test recording is carried out up to the subsequent power W5. Since the minimum jitter value differs depending on the power value, the hatched region that is tested differs depending on the power value, as represented in the matrix image shown in FIG. 30.

When the power value P4 is a pole, the power value P4 and a pulse width W2 that minimizes the jitter value for the power value P4 are used as recording condition 104. As just described, by detecting a pole of the minimum jitter value in addition to the procedure of the example shown in FIG. 26, the test region can be extended in the direction of pulse width with a small number of times of testing.

As just described, according to this embodiment, a power value and/or a pulse range used in test recording are determined based on testing of recording quality, so that a more suitable recording condition can be determined by a smaller number of times of testing.

Preferably, recording quality is tested under a recording environment that is similar to an actual recording environment in view of medium characteristics, drive characteristics, and matching therebetween, determining a test condition based on the result of testing.

Instead of changing the number of times of testing, the test region may be shifted in accordance with the result of testing of recording quality. For example, the following schemes may be employed when recording characteristics are predicted to have the same sensitivity, low sensitivity, and high sensitivity, respectively.

(1) When the Sensitivity of Recording Medium is the Same as the Sensitivity of Reference Medium

It is determined that the reference recording condition used for the prediction is close to an optimal condition. Thus, the power value and pulse width are extended by predetermined amounts with respect to the reference recording condition, and the resulting region is used as a test region. For example, when the reference recording condition is a power P and a pulse width W, the test region for the power value is P ±5 mW, and the test region for the pulse width is W ±0.2 T.

(2) When the Sensitivity of Recording Medium is Lower than the Sensitivity of the Reference Medium

It is determined that an optimal value for the recording medium requires more heat than an optimal value for the reference medium. Thus, the test region is shifted to the side of high power and wide pulse width. For example, when the reference recording condition is a power P and a pulse width W, the test region for the power value is P to P+10 mW, and the test region for the pulse width is W to W+0.4 T.

(3) When the Sensitivity of Recording Medium is Higher than the Sensitivity of the Reference Medium

It is determined that an optimal value for the recording medium requires less heat than an optimal value for the reference medium. Thus, the test region is shifted to the side of low power and narrow pulse width. For example, when the reference recording condition is a power P and a pulse width W, the test region for the power value is P −10 mW to P, and the test region for the pulse width is W −0.4 T to W.

That is, in the example described above, with respect to the power P and the pulse width W, a region formed by an area defined by a power range of 10 mW and a pulse range of 0.4 is shifted in accordance with recording characteristics so that a more suitable recording condition will be obtained. The test region may be determined based on the eight patterns shown in FIG. 14 and described earlier.

Hereinafter, an example of recording quality inspection using recording margin will be described.

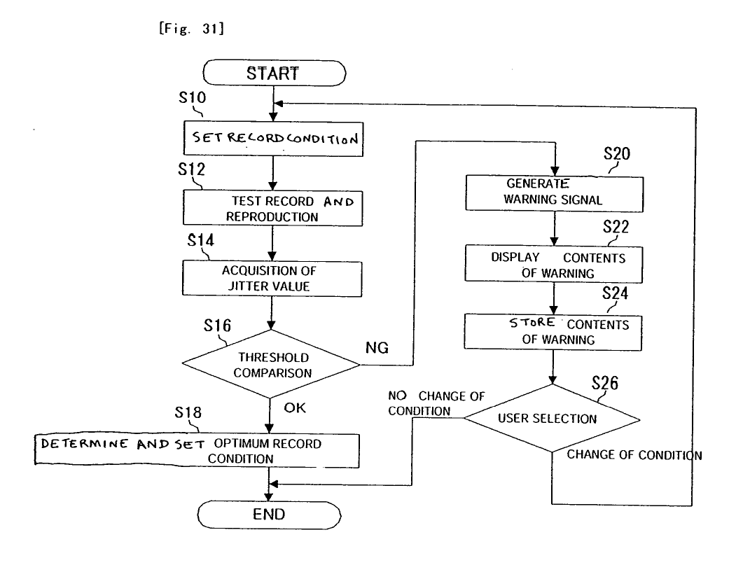

FIG. 31 is a flow chart illustrating an example of execution for the recording quality inspection before recording. As shown in the figure, first, required recording conditions, such as the pulse width, the recording power, the record reproduction speed, and the record address, are set (Step S10). Thereafter, test recording and reproduction are performed for each of the set recording conditions (Step S12) and jitter values for each recording condition is obtained (Step S14). The processes of Step S10 to S14 are repeated according to the set number of recording conditions to obtain a plurality of jitter values.

Thereafter, the obtained jitter values are compared with a specific jitter threshold (Step S16), and if they satisfy the threshold, the optimum recording condition is determined (Step S18). However, if they do not satisfy the threshold, a warning signal is generated (Step S20) and a display operation is performed in response to the warning signal (Step S22).

The generation and/or display of the warning signal may be performed within the drive or using a display device connected to the outside. At this time, measures, which are determined in accordance with the contents of warning, may be pre-stored in the drive and automatically taken when the warning signal is received.

In addition, it is possible to inform a user of error messages or measures according to the contents of warning so that the user can determine measures to be taken and approval for execution of the measures can be requested from the user. If a plurality of measures for the contents of warning is set, it is requested for the user to select desired measures (Step S26). If the user approves and selects the measures, the drive executes the selected measure.

Next, the contents of warning are stored in a storage area within the drive (Step S24), so that the generation of the warning signal and the execution of the measures based on the same recording condition are promptly achieved. It is preferable to store the contents of warning in association with ID of the drive, ID of the record object media, the recording condition, the obtained recording quality, etc. In addition, the storage of the contents of warning may be performed in the drive, on the media, or both.

If the user selects an unchanged mode of the recording condition for the contents of warning, the test record operation is ended. If the user selects a new or different mode of the recording condition, the test recording is again performed with the recording condition of Step S10 changed. Thereafter, the optimum recording condition of the recording conditions satisfying the threshold in Step S16 is decided.

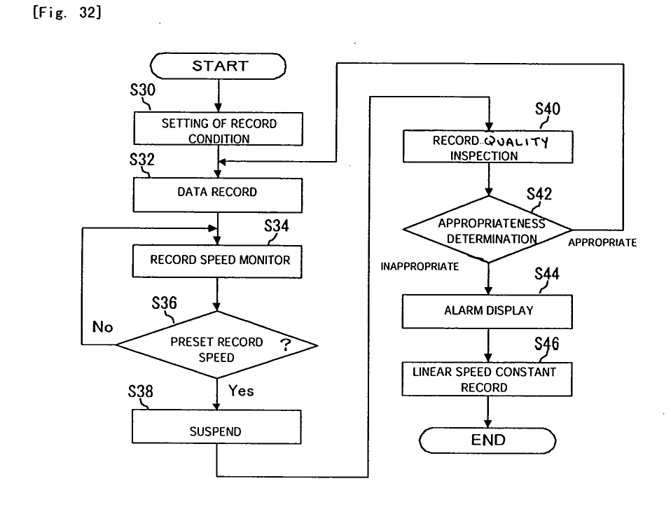

FIG. 32 is a flow chart illustrating an example of execution for the recording quality inspection after the record. In this example, first, the recording condition is set according to the sequence shown in FIG. 31 (Step S30) and data recording is performed with the set recording condition (Step S32). In addition, during this data recording, the record speed is monitored (Step S34), and when the record speed reaches a specific record speed (Yes in Step S36), the record operation is suspended (Step S38).

Thereafter, reproduction of the recorded data is performed for the recording quality inspection as described above, using a specific test recording area (Step S40). Based on a result of this inspection, it is determined whether or not recording with a given record speed is appropriate (Step S42). If it is determined that appropriate recording is feasible, the data logging of Step S32 is resumed. However, if is determined that appropriate recording is not feasible at the given speed, an alarm is displayed (Step S44) and a linear speed constant record is performed (Step S46).

Hereinafter, an example of a determination on whether or not the above-described warning signal is to be issued will be described.

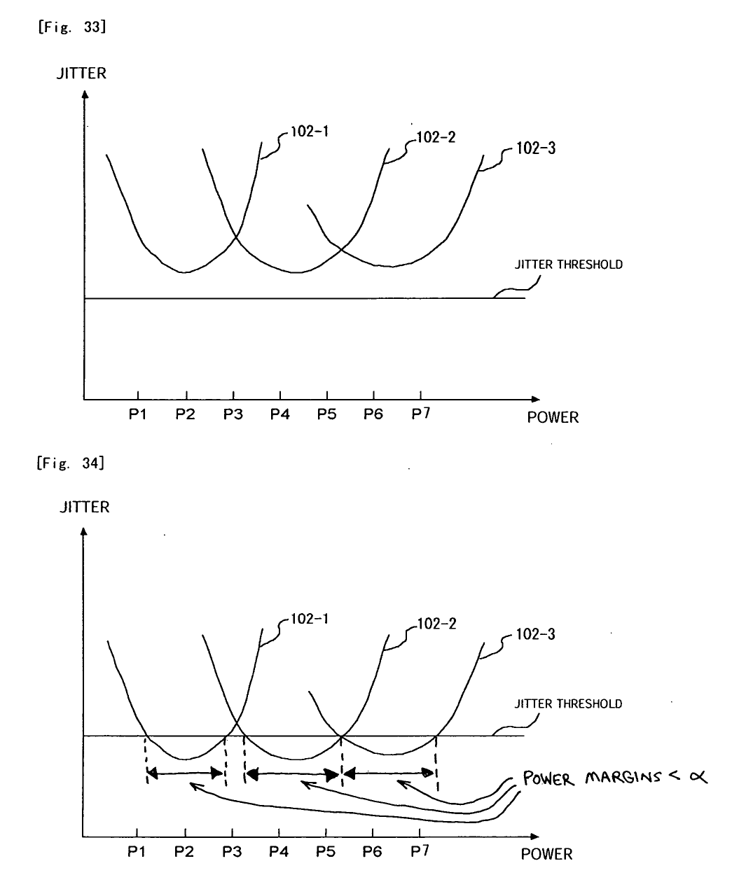

FIG. 33 is a conceptual diagram illustrating an example in which a result of the record reproduction in the test recording does not satisfy a preset threshold. As shown in the figure, the power is changed and recorded for three different pulse width conditions, and if the jitter characteristics 102-1, 102-2 and 102-3 obtained as a result of the record are above the jitter threshold value, it is determined that the record based on the recording condition is not appropriate, and thus, the warning signal is generated.

FIG. 34 is a conceptual diagram illustrating an example in which a result of the record reproduction in the test recording does not satisfy a preset amount of margin. As shown in the figure, the power is changed and recorded for three different pulse width conditions, and if there is no recording condition satisfying the amount of power margin of not less than a specific amount a although the jitter characteristics 102-1, 102-2 and 102-3 obtained as a result of the record reaches the jitter threshold value, it is determined that the record based on the recording condition is not appropriate, and thus, the warning signal is generated.

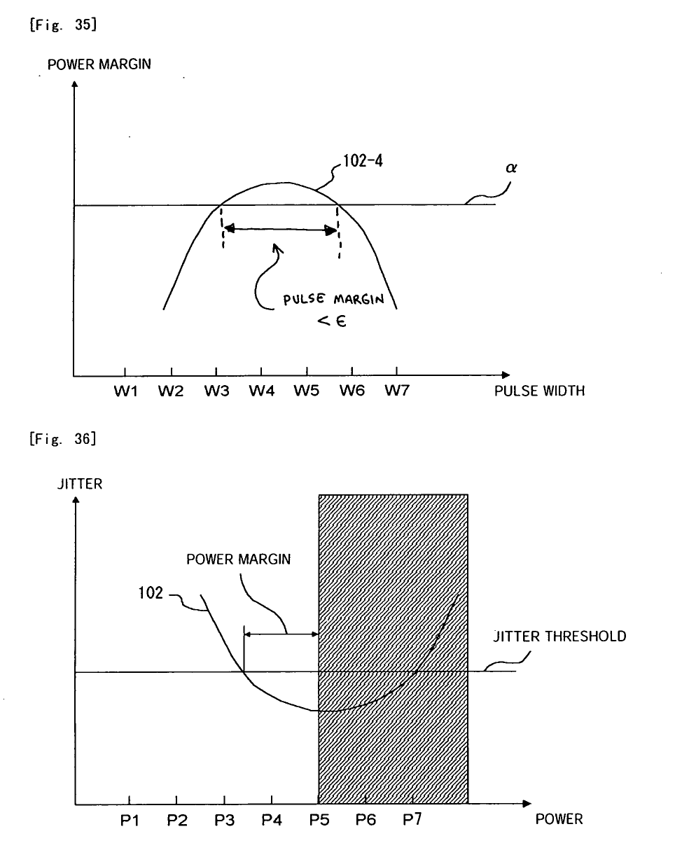

FIG. 35 is a conceptual diagram illustrating an example in which the pulse margin satisfying the power margin threshold a does not satisfy a preset amount ε. As shown in the figure, if the pulse margin of the preset amount ε is not satisfied for the change of the pulse width condition satisfying the power margin α, it is determined that the record based on the recording condition is not appropriate, and thus, the warning signal is generated.

Hereinafter, a technique of deciding the amount of margin when the power margin is not obtained within a possible range of power of the drive will be described. Here, an output upper bound power of the drive is defined as a power upper bound.

FIG. 36 is a conceptual diagram illustrating an example in which a distance between an intersecting point of a jitter curve and a jitter threshold and an intersecting point of the jitter curve and a power upper bound is taken as a power margin. As shown in the figure, if the jitter curve is blocked by a power upper bound P5, and therefore, a right end of the power margin is not measurable, the power upper bound is taken as the right end of the power margin even when the minimum jitter point is expected to be located not lower than the power upper value.

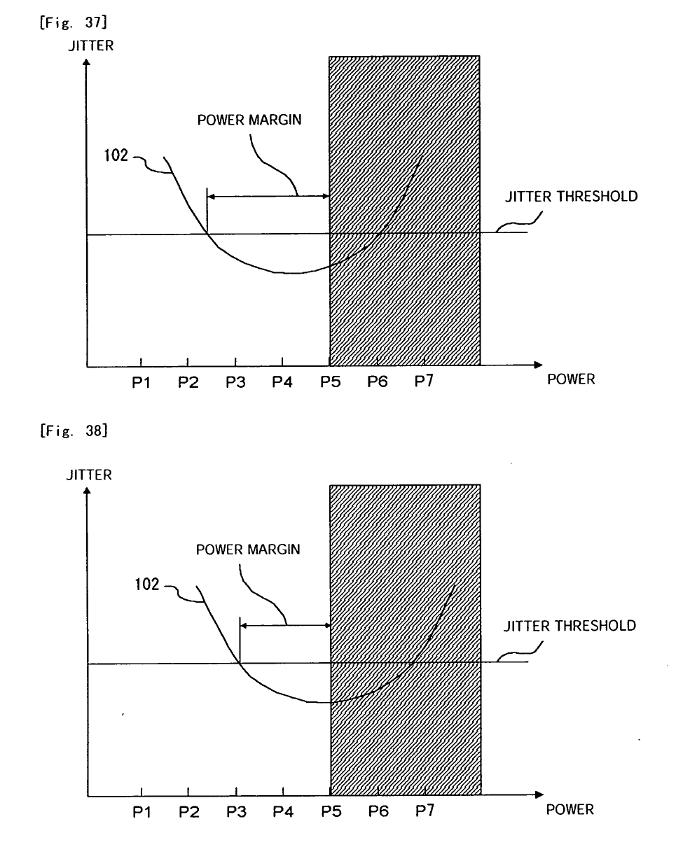

FIG. 37 is a conceptual diagram illustrating an example in which the minimum jitter point is located at a power lower than the power upper bound, as the same case as FIG. 36. In this example, a power upper bound available in the drive is taken as the right end of the power margin.

FIG. 38 is a conceptual diagram illustrating an example in which the minimum jitter point is located at the power upper bound, as the same case as FIG. 36. In this example, a power upper bound available in the drive is taken as the right end of the power margin.

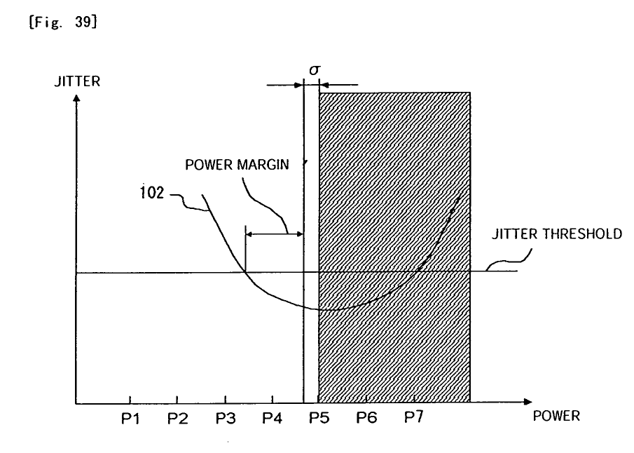

FIG. 39 is a conceptual diagram illustrating an example in which a preset amount of margin is set from the power upper bound. As shown in the figure, in expectation of a ununiformity amount σ caused by various factors such as ununiformity of setting of the recording condition, the right end of the power margin may be placed a distance σ lower than the maximum drive power. In addition, the idea of the ununiformity amount σ is also applicable to the examples of FIGS. 37 and 38.

Hereinafter, a modification of the present invention will be described.

If the warning signal as described above is generated, proper contents of warning can be delivered and proper measures according to the contents of warning can be taken by providing one or more warning values, which are determined by warning factors. Here, an example of different measures defined by different warning values is shown.

If the recording power is insufficient, that is, it is determined that a sufficient recording margin cannot be obtained due to a laser output upper bound value of the drive, the following measures pattern is provided with ‘warning value=1’ set.

Measure 1: performing the record at a lowered record speed.

Measure 2: performing the record with a changed (lengthened) record pulse width.

Measure 3: stopping the record.

If it is determined that the essence of the media is bad due to a media design, a machine characteristic etc., the following measures pattern is provided with ‘warning value=2’ set.

Measure 1: performing the record at a lowered record speed.

Measure 2: stopping the record.

If it is determined from a high speed forecast result that a high speed characteristic of the media is bad, the following measures pattern is provided with ‘warning value=3’ set.

Measure 1: performing the record with an allowable record speed as an upper bound value.

Measure 2: stopping the record.

For the same condition by a combination of the drive and the media, if the warning signal has been ever generated in the past, the warning signal is generated before the test recording, the following measures pattern is provided with ‘warning value=4’ set.

Measure 1: performing the measures according to past warning factors without performing the test recording on confirmation.

Measure 2: performing the test recording for confirmation and performing the measures according to a result of the confirmation.

Measure 3: stopping the record.

Next, an example of display of the contents of warning will be described. Here, when the user is informed of the generation of the warning signal, or when an approval or an instruction from the user is required for the execution of the measures, an exemplary method of describing the contents of warning is shown.

### DISPLAY EXAMPLE 1

### Displaying an Operation Lamp of the Drive

The generation of the warning signal is informed by a specific display pattern of the operation lamp, such as lighting on, lighting on and off, or lighting off. If the approval or the instruction from the user is required, an error comment and so on is displayed on a monitor and a response from the user is waited.

### DISPLAY EXAMPLE 2

### Displaying the Error Comment and so on the Monitor

The contents of warning to be shown to the user are indicated on the monitor. If the approval or the instruction from the user is required, a response from the user is awaited.

### DISPLAY EXAMPLE 3

### Opening the Drive Tray

The user is informed of a warning by ejecting the media. If the approval or the instruction from the user is required, an error comment and so on may be displayed on the monitor and a response from the user is waited.

### DISPLAY EXAMPLE 4

### Producing a Warning Sound

The user is informed of a warning by producing the warning sound. If the approval or the instruction from the user is required, an error comment and so on is displayed on the monitor and a response from the user is waited.

### INDUSTRIAL APPLICABILITY

According to the present invention, since more suitable recording conditions are set according to the combination of the drive and the media, it is possible to cope with any combination of the drive and the media in which information could not be recorded by the conventional techniques. As a result, the present invention is expected to be applied to a record system with a severe record environment such as a high speed record or a high density record.

1. An optical information recording apparatus for recording information on an optical recording media by pulse irradiation of laser light, comprising:
optical data writing, reading, and processing circuitry for obtaining a recording margin under defined recording conditions by comparing a reproduction characteristic with a threshold, the reproduction characteristic being obtained by writing to and reading from the optical recording media, wherein said processing circuitry is also configured to check a recording quality based on an amount of recording margin obtained.

2. The optical information recording apparatus according to claim 1,
wherein the writing is performed under different power conditions of the laser light and/or pulse conditions of the pulse irradiation.

3. The optical information recording apparatus according to claim 1,
wherein the recording margin is determined according to an amount of difference between upper and lower power values satisfying the threshold, the upper and lower power values being derived from an approximation of a recording characteristic of the optical recording media using a plurality of reproduction values obtained by the record reproduction.

4. The optical information recording apparatus according to claim 1,
wherein the recording margin is determined according to a relationship between the threshold and an approximation of a recording characteristic of the optical recording media using a plurality of reproduction values obtained by the reproducing.

5. The optical information recording apparatus according to claim 1,
wherein the recording margin is determined according to an amount of difference between upper and lower power values selected from a plurality of reproduction values obtained by the reproducing, the upper and lower values being closest to the threshold.

6. The optical information recording apparatus according to claim 1,
wherein the recording margin is determined according to a relationship between the threshold and two points selected from a plurality of reproduction values obtained by the reproducing, the two points being closest to the threshold.

7. The optical information recording apparatus according to claim 1,
wherein the recording margin is determined with reference to a power upper limit value of the laser light.

8. An optical information recording apparatus for recording information on an optical recording media by pulse irradiation of laser light comprising:
optical data writing, reading, and processing circuitry for obtaining a recording margin by comparing a reproduction characteristic with a preset standard, the reproduction characteristic being obtained by performing a test recording on the optical recording media before the information is recorded, checking a recording quality based on an amount of the recording margin determined during the test recording, and presenting a result of the inspection of the recording quality to a user of the optical recording apparatus before the information is recorded.

9. A method of optical information recording on an optical recording media by pulse irradiation of laser light, said method ocmprising:
obtaining a recording margin by comparing a reproduction characteristic with a preset standard, the reproduction characteristic being obtained by performing a test recording on the optical recording media before the information is recorded and by reproducing a result of the test recording,
inspecting a recording quality based on an amount of the recording margin, and
determining a recording condition for recording the information based on a result of the inspecting of the recording quality.

10. A method of optical information recording on an optical recording media by pulse irradiation of laser light, wherein the method comprises:
obtaining a recording margin by comparing a reproduction characteristic with a preset standard, the reproduction characteristic being obtained by performing a test recording on the optical recording media before the information is recorded and by reproducing a result of the test recording,
inspecting a recording quality based on an amount of the recording margin;
determining a recording condition for recording the information based on a condition of the test recording; and
presenting an indication that recording is inappropriate if it is determined as a result of the inspection of the recording quality that it is not appropriate to perform recording on the media.

11. A method of optical information recording on an optical recording media by pulse irradiation of laser light, wherein the method comprises:
obtaining a recording margin by comparing a reproduction characteristic with a preset standard, the reproduction characteristic being obtained by performing a test recording on the optical recording media before the information is recorded and by reproducing a result of the test recording,
inspecting a recording quality based on an amount of the recording margin, and
taking specific measures if it is determined as a result of the inspecting of a recording quality that it is not appropriate to perform the record on the media.

12. The optical information recording apparatus according to claim 11,
wherein the measures include changing a recording power condition and/or a pulse width condition when the information is recorded.

13. The optical information recording apparatus according to claim 11,
wherein the measures include recording the information based on the recording condition obtained by repeating the test recording until a desired recording quality is obtained.

14. The optical information recording apparatus according to claim 11,
wherein the measures include lowering a record speed when the information is recorded.

15. An optical information recording apparatus for recording information on an optical recording media by pulse irradiation of laser light, said apparatus comprising:
optical data writing, reading, and processing circuitry for obtaining a recording margin by comparing a reproduction characteristic with a preset standard value, the reproduction characteristic being obtained by writing data to and reading data from the optical recording media, said processing circuitry being further configured to inspect a recording quality based on a size of the recording margin, and
a memory storing a result of the inspection of the recording quality.

16. The optical information recording apparatus according to claim 15,
wherein the memory stores the recording quality and a recording condition from which the recording quality is obtained, with the recording quality and the recording condition associated with each other.

17. The optical information recording apparatus according to claim 15,
wherein the memory stores unique information of the media obtained from the recording quality.

18. The optical information recording apparatus according to claim 15,
wherein the memory stores unique information of the device for the media obtained from the recording quality.

19. The optical information recording apparatus according to claim 15,
wherein the recording quality is inspected based on a result of previous testing before the reproducing is performed for the optical recording media.

20. A method of optical information recording on an optical recording media by pulse irradiation of laser light comprising obtaining a recording margin by comparing a reproduction characteristic with a preset standard value, the reproduction characteristic being obtained by writing to and reading from the optical recording media, and inspecting a recording quality based on an amount of recording margin obtained.
